(19) United States
(12) Patent Application Publication
(10) Pub. No.: US 2024/0380522 A1
(43) Pub. Date: Nov. 14, 2024

(54) MECHANISM ON RESPONSE OF PRE-ALLOCATED RESOURCE BASED PUSCH TRANSMISSION

(71) Applicant: Intel Corporation, Santa Clara, CA (US)

(72) Inventors: Debdeep CHATTERJEE, San Jose, CA (US); Gregory V. MOROZOV, Nizhny Novgorod (RU); Sudeep PALAT, Cheltenham (GB); Sergey D. SOSNIN, Zavolzhie (RU); Gang XIONG, Portland, OR (US)

(73) Assignee: Intel Corporation, Santa Clara, CA (US)

(21) Appl. No.: 18/674,787

(22) Filed: May 24, 2024

Related U.S. Application Data
(63) Continuation of application No. 17/200,770, filed on Mar. 13, 2021.
(60) Provisional application No. 62/989,438, filed on Mar. 13, 2020.
(60) Provisional application No. 63/138,617, filed on Jan. 18, 2021.

(51) Int. Cl. H04L 1/1812; H04W 72/044; H04W 72/21; H04W 76/27

(52) U.S. Cl. CPC H04L 1/1812; H04W 72/046; H04W 72/21; H04W 76/27

(57) ABSTRACT

Provided herein are mechanisms on response of pre-allocated resource based PUSCH transmission. The disclosure provides an apparatus including processor circuitry. The processor circuitry is to: encode data, for transmission to an access node (AN) over a pre-allocated uplink (UL) resource (PUR) based physical uplink shared channel (PUSCH); start a timer once the data is transmitted; and monitor, based on the timer, a physical downlink control channel (PDCCH) to obtain a response of the AN to the transmission of the data. Other embodiments may also be disclosed and claimed.

### CROSS REFERENCE TO RELATED APPLICATION

This application is a continuation of U.S. Patent Application No. U.S. Ser. No. 17/200,770, filed on Mar. 13, 2021, which is based on and claims priority to U.S. provisional application No. 62/989,438 filed on Mar. 13, 2020 and U.S. provisional application No. 63/138,617 filed on Jan. 18, 2021. The aforementioned patent applications are hereby incorporated by reference in their entireties

### TECHNICAL FIELD

Embodiments of the present disclosure generally relate to wireless communications, and in particular to mechanisms on response of pre-allocated resource based PUSCH transmission.

### BACKGROUND ART

Mobile communication has evolved significantly from early voice systems to today's highly sophisticated integrated communication platform. The next generation wireless communication system, the fifth generation (5G), or new radio (NR) will provide access to information and sharing of data anywhere, anytime by various terminals and applications. NR is expected to be a unified network/system that targets to meet vastly different and sometime conflicting performance dimensions and services. Such diverse multi-dimensional requirements are driven by different services and applications. In general, NR may evolve based on the 3rd Generation Partnership Project (3GPP) Long Term Evolution (LTE)-Advanced with additional potential new Radio Access Technologies (RATs) to enrich people's lives with better, simple and seamless wireless connectivity solutions. NR may enable everything connected by wireless and deliver fast, rich contents and services.

### BRIEF DESCRIPTION OF THE DRAWINGS

Embodiments of the disclosure will be illustrated, by way of example and not limitation, in the figures of the accompanying drawings in which like reference numerals refer to similar elements.

FIG. 1 illustrates a communication system in accordance with some embodiments of the disclosure.

FIG. 2 illustrates a 2-step RACH procedure.

FIG. 3 illustrates a flowchart of a method for validation of TA for PUR based PUSCH transmission in accordance with some embodiments of the disclosure.

FIG. 4 illustrates a flowchart of a method for configuration of RA-SDT in accordance with some embodiments of the disclosure.

FIG. 5 illustrates a flowchart of a method for configuration of RA-SDT in accordance with some embodiments of the disclosure.

FIG. 6 illustrates a procedure of response of PUR based PUSCH transmission in accordance with some embodiments of the disclosure.

FIG. 7 illustrates a flowchart of a method for response of PUR based PUSCH transmission in accordance with some embodiments of the disclosure.

FIG. 8 illustrates an example of infrastructure equipment in accordance with various embodiments.

FIG. 9 is a block diagram illustrating components, according to some example embodiments, able to read instructions from a machine-readable or computer-readable medium and perform any one or more of the methodologies discussed herein.

FIG. 10 illustrates a network in accordance with various embodiments.

FIG. 11 schematically illustrates a wireless network in accordance with various embodiments.

FIG. 12 illustrates example components of a device in accordance with some embodiments of the disclosure.

### DETAILED DESCRIPTION OF EMBODIMENTS

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

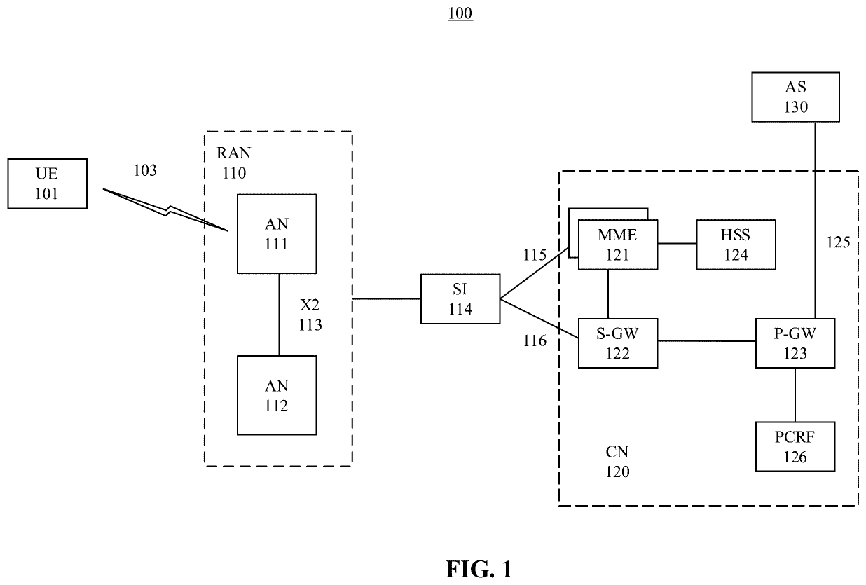

FIG. 1 illustrates a communication system 100 in accordance with some embodiments of the disclosure. The communication system 100 is shown to include a user equipment (UE) 101. The UE 101 may be a smartphone (e.g., a handheld touchscreen mobile computing device connectable to one or more cellular networks). However, it may also include any mobile or non-mobile computing device, such as a personal data assistant (PDA), a tablet, a pager, a laptop computer, a desktop computer, a wireless handset, or any computing device including a wireless communications interface.

In some embodiments, the UE 101 may include an Internet of Things (IoT) UE, which may include a network access layer designed for low-power IoT applications utilizing short-lived UE connections. An IoT UE may utilize technologies such as machine-to-machine (M2M), machine-type communications (MTC), enhance MTC (eMTC), and narrow band IoT (NB-IoT) for exchanging data with an IoT server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UE 101 may be configured to connect, e.g., communicatively couple, with a radio access network (RAN) 110, which may be, for example, an Evolved Universal Mobile Telecommunications System (UMTS) Terrestrial Radio Access Network (E-UTRAN), a NextGen RAN (NG RAN), or some other type of RAN. The UE 101 may operate in consistent with cellular communications protocols, such as a Global System for Mobile Communications (GSM) protocol, a Code-Division Multiple Access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

The RAN 110 may include one or more access nodes (ANs). These ANs may be referred to as base stations (BSs), NodeBs, evolved NodeBs (eNBs), next Generation NodeBs (gNBs), and so forth, and may include ground stations (e.g., terrestrial access points) or satellite stations providing coverage within a geographic area (e.g., a cell). As shown in FIG. 1, for example, the RAN 110 includes AN 111 and AN 112.

The UE 101 may enable communicative coupling with the RAN 110 by utilizing connection 103 with AN 111, as shown in FIG. 1. The connection 103 may be implemented with one or more beams (not shown). A beam may indicate a spatial domain transmission and/or reception filter or spatial relation, thus, term “beam”, “spatial domain transmission and/or reception filter” and “spatial relation” may be interchangeable herein.

The AN 111 and AN 112 may communicate with one another via an X2 interface 113. The AN 111 and AN 112 may be macro ANs which may provide lager coverage. Alternatively, they may be femtocell ANs or picocell ANs, which may provide smaller coverage areas, smaller user capacity, or higher bandwidth compared to a macro AN. For example, one or both of the AN 111 and AN 112 may be a low power (LP) AN. In an embodiment, the AN 111 and AN 112 may be the same type of AN. In another embodiment, they are different types of ANs.

The AN 111 may terminate the air interface protocol and may be the first point of contact for the UE 101. In some embodiments, the ANs 111 and 112 may fulfill various logical functions for the RAN 110 including, but not limited to, radio network controller (RNC) functions such as radio bearer management, uplink and downlink dynamic radio resource management and data packet scheduling, and mobility management.

In accordance with some embodiments, the UE 101 may be configured to communicate using Orthogonal Frequency-Division Multiplexing (OFDM) communication signals with the AN 111 or with other UEs over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and Proximity-Based Service (ProSe) or sidelink communications), although the scope of the embodiments is not limited in this respect. The OFDM signals can include a plurality of orthogonal subcarriers.

In some embodiments, a downlink resource grid may be used for downlink transmissions from the AN 111 to the UE 101, while uplink transmissions may utilize similar techniques. The grid may be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

Downlink channels may include a physical downlink shared channel (PDSCH) and a physical downlink control channel (PDCCH).

The PDSCH may carry user data and higher-layer signaling to the UE 101. The PDCCH may carry information about the transport format and resource allocations related to the PDSCH channel, among other things. It may also inform the UE 101 about the transport format, resource allocation, and Hybrid Automatic Repeat Request (HARQ) information related to the uplink shared channel. Typically, downlink scheduling (assigning control and shared channel resource blocks to the UE 101 within a cell) may be performed at the AN 111 based on channel quality information fed back from the UE 101. The downlink resource assignment information may be sent on the PDCCH used for (e.g., assigned to) the UE 101.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There may be four or more different PDCCH formats defined in LTE with different numbers of CCEs (e.g., aggregation level, L=1, 2, 4, or 8)

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced control channel elements (ECCEs). Similar to above, each ECCE may correspond to nine sets of four physical resource elements known as an enhanced resource element groups (EREGs). An ECCE may have other numbers of EREGs in some situations.

Uplink channels may include a physical uplink shared channel (PUSCH) and a physical uplink control channel (PUCCH). The PUSCH may carry user data and control information to the AN(s), and the PUCCH may carry control information to the AN(s).

The RAN 110 is shown to be communicatively coupled to a core network (CN) 120 via a S1 interface 114. In some embodiments, the CN 120 may be an evolved packet core (EPC) network, a NextGen Packet Core (NPC) network, or some other type of CN. In an embodiment, the S1 interface 114 is split into two parts: the Si-mobility management entity (MME) interface 115, which is a signaling interface between the ANs 111 and 112 and MMEs 121; and the S1-U interface 116, which carries traffic data between the ANs 111 and 112 and a serving gateway (S-GW) 122.

In an embodiment, the CN 120 may comprise the MMEs 121, the S-GW 122, a Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 114 towards the RAN 110, and routes data packets between the RAN 110 and the CN 120. In addition, the S-GW 122 may be a local mobility anchor point for inter-AN handovers and also may provide an anchor for inter-3GPP mobility. Other responsibilities may include lawful intercept, charging, and some policy enforcement.

The P-GW 123 may terminate a SGi interface toward a PDN. The P-GW 123 may route data packets between the CN 120 and external networks such as a network including an application server (AS) 130 (alternatively referred to as application function (AF)) via an Internet Protocol (IP) interface 125. Generally, the application server 130 may be an element offering applications that use IP bearer resources with the core network (e.g., UMTS Packet Services (PS) domain, LTE PS data services, etc.). In an embodiment, the P-GW 123 is communicatively coupled to an application server 130 via an IP communications interface. The application server 130 may also be configured to support one or more communication services (e.g., Voice-over-Internet Protocol (VoTP) sessions, PTT sessions, group communication sessions, social networking services, etc.) for the UE 101 via the CN 120.

The P-GW 123 may further be responsible for policy enforcement and charging data collection. Policy and Charging Rules Function (PCRF) 126 is a policy and charging control element of the CN 120. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 126 may be communicatively coupled to the application server 130 via the P-GW 123. The application server 130 may signal the PCRF 126 to indicate a new service flow and select the appropriate Quality of Service (QoS) and charging parameters. The PCRF 126 may provision this rule into a Policy and Charging Enforcement Function (PCEF) (not shown) with an appropriate traffic flow template (TFT) and QoS class of identifier (QCI), which commences the QoS and charging as specified by the application server 130.

The quantity of devices and/or networks illustrated in FIG. 1 is provided for explanatory purposes only. In practice, there may be additional devices and/or networks, fewer devices and/or networks, different devices and/or networks, or differently arranged devices and/or networks than illustrated in FIG. 1. Alternatively or additionally, one or more of the devices of system 100 may perform one or more functions described as being performed by another one or more of the devices of system 100. Furthermore, while “direct” connections are shown in FIG. 1, these connections should be interpreted as logical communication pathways, and in practice, one or more intervening devices (e.g., routers, gateways, modems, switches, hubs, etc.) may be present.

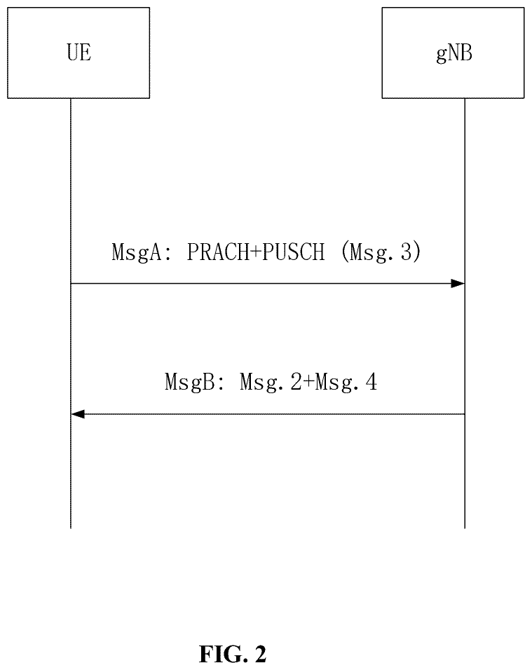

In Rel-15 NR, 4-step random access (RACH) procedure is defined. Further, in Rel-16 NR, 2-step RACH procedure is under the discussion, with the motivation to allow fast access and low latency uplink transmission. More specifically, for 2-step RACH procedure, in the first step, UE transmits a physical random access channel (PRACH) preamble and associated MsgA physical uplink shared channel (PUSCH) on a configured time and frequency resource. The MsgA PUSCH may carry at least equivalent contents of Msg3 in 4-step RACH. After successful detection of PRACH preamble and decoding of MsgA PUSCH, gNB transmits MsgB in the second step. The MsgB may carry equivalent contents of Msg2 and Msg4 in 4-step RACH. FIG. 2 illustrates a 2-step RACH procedure.

For certain scenarios, e.g., small cell network or industrial wireless sensor network (IWSN) where most of sensors are stationary, PRACH preamble transmission in the 2-step RACH procedure may not be needed since timing advance is either within the length of a cyclic prefix (CP) by the deployment or with little change.

In this case, direct data transmission on PUSCH within pre-allocated UL resource (PUR) may be considered without associated PRACH preamble transmission, which may help to reduce data transmission delay and save UE power consumption. Moreover, for UEs in a RRC_INACTIVE mode, small data transmission can be completed without moving into RRC_CONNECTED mode, thereby saving state transition signaling overhead.

PUR based PUSCH transmission can be defined in accordance with configured grant based PUSCH transmission when timing advance (TA) value is valid. In this case, certain mechanism needs to be defined to ensure the validation of TA value for PUR based PUSCH transmission

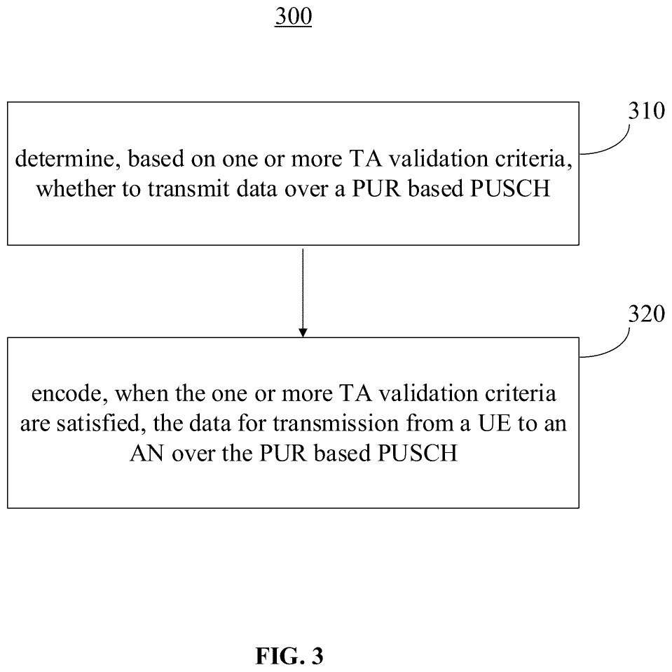

FIG. 3 illustrates a flowchart of a method 300 for validation of TA for PUR based PUSCH transmission in accordance with some embodiments of the disclosure. The method 300 may include steps 310 and 320. The method 300 may be performed by a UE.

At 310, based on one or more TA validation criteria, it is determined whether to transmit data over a PUR based PUSCH.

At 320, when the one or more TA validation criteria are satisfied, the data is encoded for transmission from a UE to an AN over the PUR based PUSCH.

In some embodiments, the one or more TA validation criteria may include at least one of: a TA validation rule for a RRC_INACTIVE mode; a serving cell of the UE keeping unchanged; a transmitting (Tx) beam for the transmission of the data keeping unchanged; or a measured reference signal received power (RSRP) corresponding to a synchronization signal (SS)/physical broadcast channel (PBCH) block (SSB) index for the UE being greater than or equal to a threshold.

In some embodiments, when a TA validation rule is satisfied for RRC_INACTIVE mode, the PUR based PUSCH may be transmitted, using the latest TA value. Otherwise, the UE may not transmit the PUR based PUSCH.

In some embodiments, if the serving cell of the UE is changed, the UE may not transmit the PUR based PUSCH. Alternatively or additionally, if a measured RSRP change is greater than or equal to a certain threshold, the UE may not transmit the PUR based PUSCH. The threshold may be configured by higher layer via, for example, NR remaining minimum system information (RMSI), NR other system information (OSI) or dedicated radio resource control (RRC) signaling. The present disclosure is not limited in this respect.

In some embodiments, if a time alignment timer is not running, which indicates the last TA value is not valid, the UE may not transmit the PUR based PUSCH.

In some embodiments, if a Tx beam for the PUR based PUSCH transmission is changed, UE may not transmit the PUR based PUSCH transmission. In an example, after measurement, UE identifies that the Tx beam which is determined in accordance with spatialRelationInfo associated with sounding reference signal (SRS) resource indicator (or srs-ResourceIndicator) is changed above certain threshold, the UE may not transmit the PUR based PUSCH transmission. The boundary condition (for example, defining the threshold) to define the Tx beam change may be based on, for example, at least one of: change in the index of the corresponding SRS Resource Indicator (SRI), RSRP (higher layer filtered RSRP or Layer-1-RSRP) for the corresponding beam(s), if available, in the DL. The present disclosure is not limited in this respect.

In some embodiments, if the UE is configured with the higher layer parameter spatialRelationInfo containing the ID of a reference ‘ssb-Index’, and if the UE identifies different SSB indexes based on measurement from the configured SSB index, the UE may not transmit the PUR based PUSCH. Similarly, if the higher layer parameter spatialRelationInfo contains the ID of a reference ‘csi-RS-Index’, and if the UE identifies different CSI-RS indexes based on measurement from the configured CSI-RS index, the UE may not transmit the PUR based PUSCH. In some cases, this may be defined in conjunction with RSRP change for TA validation. For example, if both Tx beam change and RSRP change are above certain thresholds, the UE may not transmit the PUR based PUSCH transmission.

In some embodiments, the aforementioned one or more criteria for TA validation may be configured via RMSI (SIB1), OSI or RRC signaling. In some embodiments, if one criterion is not configured for TA validation, UE may still transmit the PUR based PUSCH even when the criterion is not met.

In some embodiments, if the UE is configured with the higher layer parameter spatialRelationInfo containing the ID of a reference ‘ssb-Index’, and if the measured RSRP in accordance with the indicated SSB index is less than a threshold, UE may not use the associated configured grant PUSCH (CG-PUSCH) resource for small data transmission.

Embodiments of validation of TA for PUR based PUSCH transmission are described above. Below, configuration of RACH based small data transmission (RA-SDT) will be detailed.

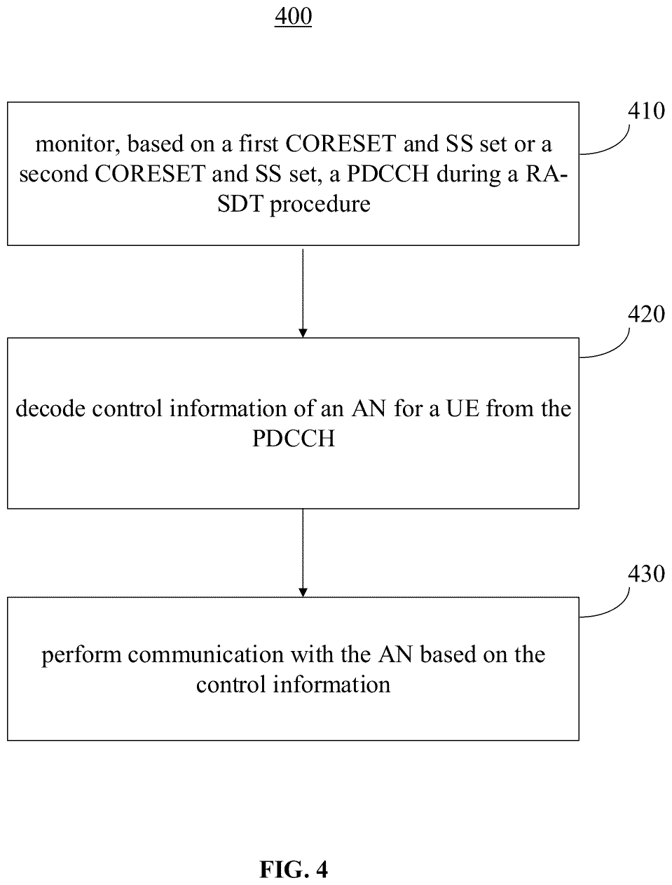

FIG. 4 illustrates a flowchart of a method 400 for configuration of RA-SDT in accordance with some embodiments of the disclosure. The method 400 may include steps 410, 420 and 430. The method 400 may be performed by a UE.

At 410, based on a first control resource set (CORESET) and search space (SS) set or a second CORESET and SS set, a PDCCH is monitored during a RACH based small data transmission (RA-SDT) procedure. The first CORESET and SS set may be dedicated for PDCCH monitoring during the RA-SDT procedure, and the second CORESET and SS set may be used for detecting DCI format with Cyclic Redundancy Error (CRC) scrambled with random access-radio network temporary identifier (RNTI) (RA-RNTI) or Typel-PDCCH common search space (CSS) set.

At 420, control information of an AN for a UE is decoded from the PDCCH.

At 430, communication with the AN is performed based on the control information.

In some embodiments, for RRC_INACTIVE states, the UE may send multiple UL packets or receive DL packets as part of RA-SDT mechanism, and the UE needs to monitor the PDCCH addressed to a cell-Radio Network Temporary Identifier (C-RNTI) after successful completion of the RACH procedure during the RA-SDT procedure. In some embodiments, if the UE is configured with dedicated configuration of CORESET and SS set for PDCCH monitoring during the RA-SDT procedure and the configuration is still valid for the RA-SDT procedure, the UE may monitor the PDCCH with CRC scrambled with C-RNTI according to the configured CORESET and SS set. Alternatively or additionally, in some cases, UE may monitor the PDCCH based on the CORESET and SS set used for detecting DCI format with CRC scrambled with RA-RNTI, or Typel-PDCCH CSS set.

In some embodiments, if the UE is not configured with dedicated configuration for CORESET and SS set for the RA-SDT procedure, the UE may monitor PDCCH according to the CORESET and SS set used for detecting DCI format with CRC scrambled with RA-RNTI or Typel-PDCCH CSS set.

In some embodiments, instead of separate configurations for both SS set and CORESET for monitoring during the RA-SDT procedure, the UE may be configured with a separate configuration only for the SS set for PDCH monitoring during the RA-SDT procedure. For instance, the separately configured SS set may map to CORESET #0 as indicated by the SSB.

In some embodiments, UE may always monitor the PDCCH during the RA-SDT procedure according to the CORESET and SS set used for detecting DCI format with CRC scrambled with RA-RNTI or Typel-PDCCH CSS set.

For RRC_INACTIVE states, the UE may receive DL packets as part of RA-SDT mechanism and the UE may need to send HARQ response on an indicated PUCCH resource.

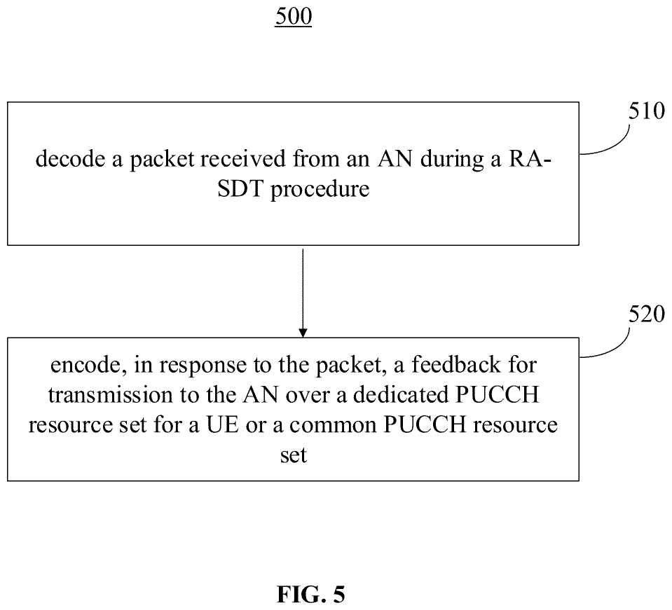

FIG. 5 illustrates a flowchart of a method 500 for configuration of RA-SDT in accordance with some embodiments of the disclosure. The method 500 may include steps 510 and 520. The method 500 may be performed by a UE.

At 510, a packet received from an AN during a RA-SDT procedure is decoded.

At 520, in response to the packet, a feedback is encoded for transmission to the AN over a dedicated PUCCH resource set for a UE or over a common PUCCH resource set.

In some embodiments, the PUCCH resource set for the UE to provide the feedback (e.g., HARQ-ACK feedback) during the RA-SDT procedure may be configured by dedicated configuration. In some embodiments, if the dedicated configuration for the PUCCH resource set is valid for RA-SDT, the UE may transmit the feedback in accordance with the dedicated PUCCH resource set.

In some embodiments, if the dedicated configuration is not provided or if the dedicated configuration is not valid for RA-SDT, the UE may transmit the feedback in accordance with the common PUCCH resource set. In some embodiments, the common PUCCH resource set is configured by pucch-ResourceCommon in RMSI, which is used to indicate 16 cell-specific PUCCH resources.

In some embodiments, the UE may always use the common PUCCH resource set for feedback of DL transmission during the RA-SDT procedure.

Embodiments of validation of TA for PUR based PUSCH transmission and configuration of RA-SDT are described above. Below, response of PUR based PUSCH transmission will be detailed.

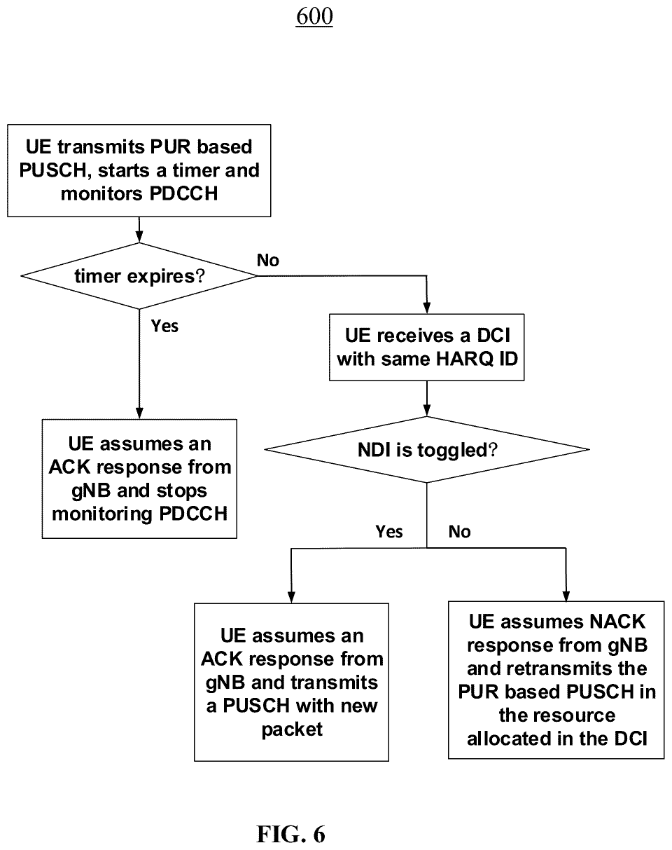

FIG. 6 illustrates a procedure 600 of response of PUR based PUSCH transmission in accordance with some embodiments of the disclosure.

As shown in the procedure 600, after the UE transmits a PUR based PUSCH transmission, the UE starts a timer and monitors PDCCH in a search space. When the time expires, UE assumes that the PUSCH is correctly received by gNB. If the UE receives a DCI before the timer expires and the DCI includes a same HARQ process ID as for the initial PUSCH transmission, a further determination is performed based on a new data indicator (NDI) of the DCI. If the NDI is toggled so as to indicate that a new data transmission is allowed, UE assumes that the PUSCH is correctly received by the AN, and the UE may transmit a new packet in accordance with the scheduling/resource allocation in the DCI. If the NDI is not toggled so as to indicate that a new data transmission is not allowed, the UE assumes that the PUSCH is not correctly received by the AN, and the UE may retransmit the PUSCH in the allocated resource indicated in the DCI.

The procedure 600 is an example for response of PUR based PUSCH transmission. The present disclosure is not limited in this respect.

In some embodiments, if an indication in the DCI indicates a fallback mode for PUR based PUSCH transmission, the ULE may fallback to the 2-step or 4-step RACH procedure for small data transmission. The selection of 2-step and 4-step RACH procedure may be based on as defined NR Rel-16 specification.

In some embodiments, configuration of PUR based PUSCH transmission may be configured by dedicated RRC signaling. In a case when the configuration of PUR based PUSCH transmission is not configured, the UE may use the configuration which is configured for Type 1 configured grant PUSCH transmission. Further, when multiple configurations are configured for Type 1 configured grant PUSCH transmission, the configuration of PUR based PUSCH transmission may use one of the multiple configurations for Type 1 configured grant PUSCH transmission, for example, one with lowest ID among multiple configurations. The present disclosure is not limited in this respect.

In some embodiments, the duration of the timer may be configured by higher layer via RMSI (SIB1), OSI or RRC signaling. The timer may be defined in unit of slot or millisecond. The slot may be based in accordance with active UL bandwidth part (BWP) or initial UL BWP.

In some embodiments, in the above procedure, UE may monitor PDCCH for a DCI format with CRC scrambled by a C-RNTI or a RNTI which is configured by higher layer via RMSI (SIB1), OSI or dedicated RRC signaling. For instance, PUR-RNTI may be configured for PUR based operation. The DCI format may be based on DCI 0_0 for fallback DCI format scheduling PUSCH.

In some embodiments, HARQ ID used for the PUR based PUSCH transmission may be determined in accordance with the HARQ ID determined rule as defined for configured grant in Section 5.4.1 in 3GPP TS 38.321 V15.8.0 (2019-12) (3rd Generation Partnership Project; Technical Specification Group Radio Access Network; NR; Medium Access Control (MAC) protocol specification (Release 15)).

In some embodiments, the PUR-RNTI may be a regular C-RNTI obtained by the UE for its previous operation in RRC_CONNECTED mode and further kept in RRC_INACTIVE after UE's transition to this mode, at least until when the TA is considered as valid.

In some embodiments, the UE may monitor DCI in a CSS or a UE specific search space (USS). The UE may receive PDCCH for Type 1-PDCCH or a new Type PDCCH CSS set.

For example, the specification in 3GPP TS 38.213 V16.0.0 (2019-12) (3rd Generation Partnership Project; Technical Specification Group Radio Access Network; NR; Physical layer procedures for control (Release 16)) or 3GPP TS 38.214 V16.0.0 (2019-12) (3rd Generation Partnership Project; Technical Specification Group Radio Access Network; NR; Physical layer procedures for data (Release 16)) can be updated similar to the following.

In response to a transmission of a PUR based PUSCH, a UE attempts to detect a DCI
format 1_0 with CRC scrambled by a corresponding PUR-RNTI or C-RNTI during a window
controlled by higher layers. The window starts at the first symbol of the earliest CORESET
the UE is configured to receive PDCCH for Type1-PDCCH or a new Type-PDCCH CSS set,
that is at least one symbol, after the last symbol of the PUSCH occasion corresponding
to the PUSCH transmission, where the symbol duration corresponds to the SCS for
Type1-PDCCH or the new Type-PDCCH CSS set. The length of the window in number of
slots, based on the SCS for Type1-PDCCH CSS set, is provided by higher layers.

In some embodiments, the indication of fallback mode for PUR based PUSCH transmission may be explicitly indicated in the DCI or re-purposed from the existing field in the DCI. In this case, UE may fallback to the 2-step or 4-step RACH procedure for small data transmission.

In some embodiments, 1-bit indicator in the DCI may be used to indicate whether fallback mode is triggered. In particular, bit ‘1’ may be used to indicate that UE needs to fallback to 2-step or 4-step RACH procedure for small data transmission; while bit ‘0’ may be used to indicate that UE needs to continue with PUR based PUSCH transmission, and vice versa.

In some embodiments, if HARQ process number is set to all ‘0’s, and/or if redundancy version is set to all ‘0’s, and/or if modulation and coding scheme is set to all ‘1’s, and/or frequency domain resource assignment is set to all ‘1’s, the UE may perform fallback mode for PUR based PUSCH transmission.

In some embodiments, if HARQ process number is set to the HARQ ID determined in accordance with configured grant uplink transmission (as defined in3GPP TS 38.321 V15.8.0 (2019-12)), and/or if redundancy version is set to all ‘0’s, and/or if modulation and coding scheme is set to all ‘1’s, and/or frequency domain resource assignment is set to all ‘1’s, the UE may perform fallback mode for PUR based PUSCH transmission.

In some embodiments, an explicit HARQ-ACK feedback of PUR based PUSCH transmission may be included in the DCI. This may be used for the case when gNB successfully decodes the PUR based PUSCH and does not schedule another PUSCH transmission. In some cases, the HARQ-ACK feedback may only include ACK or include both ACK and NACK.

In some embodiments, the explicit HARQ-ACK feedback may be jointly indicated with fallback mode indicator in the DCI. For instance, 1-bit indicator may be included in the DCI, where bit ‘1’ may be used to indicate that UE needs to fallback to 2-step or 4-step RACH procedure for small data transmission; while bit ‘0’ may be used to indicate the ACK response from gNB, or vice versa. The section of 2-step RACH and 4-step RACH can follow the specification as defined in Rel-16. In another option, 2-bit indicator in the DCI may be used to indicate the selection of 2-step and 4-step RACH procedure, as well as ACK response from gNB.

In some embodiments, some fields in the DCI may be repurposed to indicate the HARQ-ACK response in the DCI. Similar to aforementioned method, if HARQ process number is set to all ‘0’s, and/or if redundancy version is set to all ‘0’s, and/or if modulation and coding scheme is set to all ‘1’s, and/or frequency domain resource assignment is set to all ‘1’s, UE may assume ACK response from gNB for the corresponding PUR based PUSCH transmission.

In some embodiments, if HARQ process number is set to the HARQ ID determined in accordance with configured grant uplink transmission (as defined in 3GPP TS 38.321 V15.8.0 (2019-12)), and/or if redundancy version is set to all ‘0’s, and/or if modulation and coding scheme is set to all ‘1’s, and/or frequency domain resource assignment is set to all ‘1’s, UE may assume ACK response from gNB for the corresponding PUR based PUSCH transmission.

In some embodiments, TA adjustment value may be explicitly included in the DCI for response of PUR based PUSCH transmission. After UE receives the TA adjustment value in the DCI, UE may adjust the TA value in k slots after the start or end of PDCCH. k may be predefined in the specification or configured by higher layers via RMSI (SIB1), OSI or RRC signaling. The slot may be defined in accordance with UL BWP including active UL BWP or initial UL BWP.

In some embodiments, the timing for TA adjustment may follow the specification as defined in Section 4.2 in 3GPP TS 38.213 V16.0.0 (2019-12).

In some embodiments, when the UE receives a TA adjustment command in the DCI, T_{A}, for a TAG to indicate adjustment of a current N_{TA} value, N_{TA_old}, to the new N_{TA} value, N_{TA_new}, by index values of T_{A}=0, 1, 2, . . . , 63. For a SCS of 2^{μ}·15 kHz, N_{TA_new}=N_{TA_old}+(T_{A}−31) 16·64/2^{μ}.

In some embodiments, the granularity of the TA value in the DCI may be determined by the same table for the granularity of the TA command in 4-step RACH RAR with the subcarrier spacing (kHz) value which is based on the UL BWP SCS. More specifically, the granularity of the TA value may be determined based on Table 1.

TABLE 1
Granularity of the TA value

| Subcarrier Spacing (kHz) of PUR based | |
|---|---|
| PUSCH transmission | Unit |
| 15 | 16*64 Tc |
| 30 | 8*64 Tc |
| 60 | 4*64 Tc |
| 120 | 2*64 Tc |

In some embodiments, for RRC_INACTIVE mode, the UE needs to monitor DCI format 2_0 to receive information from gNB for dynamic slot format indicator (SFI). After UE obtains the dynamic SFI information, UE may cancel the PUSCH transmission according to the rule as defined in 3GPP TS 38.213 V16.0.0 (2019-12).

In some embodiments, the UE may be configured to not transmit PUSCH using PUR on transmission occasions that overlap at least with one symbol that is indicated as Downlink (DL) or Flexible (X) symbols via tdd-UL-DL-ConfigurationDedicated if provided when it was last in RRC_CONNECTED mode, or via tdd-UL-DL-ConfigurationCommon if provided. Further, at least when the UE is configured to not transmit PUSCH using PUR on transmission occasions that overlap with any semi-statically configured Flexible symbols, the UE does not expect to be configured with PUR configuration if it is not provided with at least one of tdd-UL-DL-ConfigurationCommon and tdd-UL-DL-ConfigurationDedicated.

In some embodiments, after UE transmits PUR based PUSCH using configured SRS resource indicator, when UE monitors PDCCH with CRC scrambled by PUR-RNTI or C-RNTI, the UE may assume that same Tx beam which is indicated via SRS resource indicator for the corresponding spatialRelationInfo is used for PDCCH transmission.

In some embodiments, if the UE detects a DCI format 1_0 with CRC scrambled by the corresponding PUR-RNTI or C-RNTI, the UE may assume same DM-RS antenna port quasi co-location properties, as described in 3GPP TS 38.214 V16.0.0 (2019-12), as for spatialRelationInfo indicated by srs-ResourceIndicator the UE used for PUSCH transmission, as described in Subclause 8.1, regardless of whether or not the UE is provided with TCI-State for the CORESET where the UE receives the PDCCH with the DCI format 1_0.

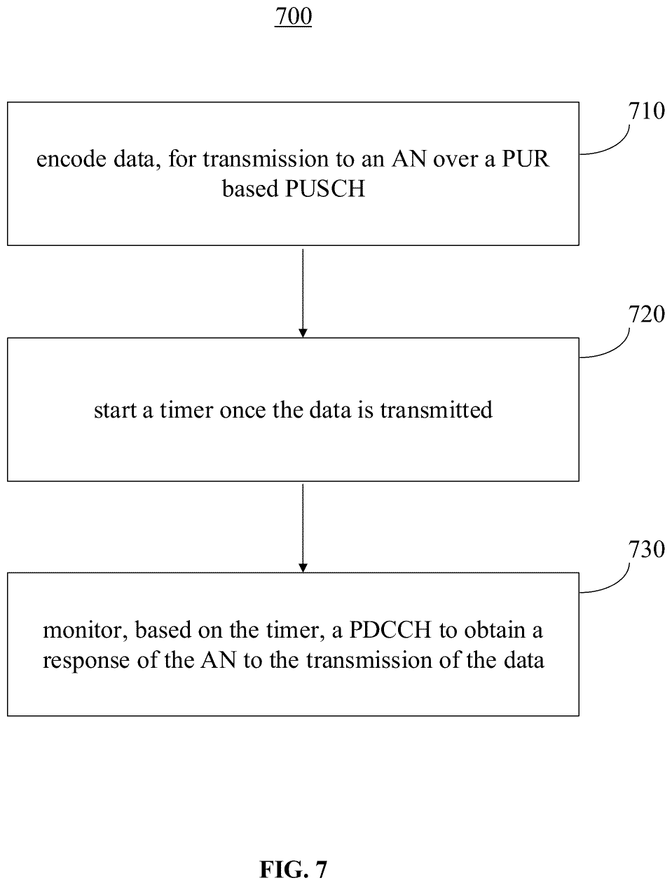

FIG. 7 illustrates a flowchart of a method 700 for response of PUR based PUSCH transmission in accordance with some embodiments of the disclosure. The method 700 may include steps 710, 720 and 730. The method 700 may be performed by a UE.

At 710, data is encoded, for transmission to an AN over a PUR based PUSCH.

At 720, a timer is started once the data is transmitted.

At 730, based on the timer, a PDCCH is monitored to obtain a response of the AN to the transmission of the data.

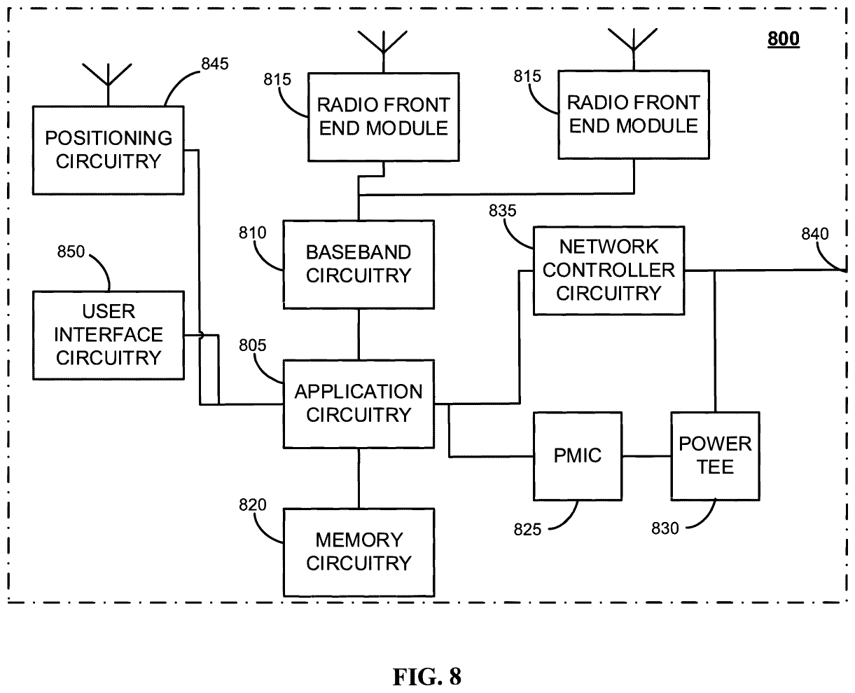

FIG. 8 illustrates an example of infrastructure equipment 800 in accordance with various embodiments. The infrastructure equipment 800 (or “system 800”) may be implemented as a client, a server, etc., such as the client and the server shown and described previously. In other examples, the system 800 could be implemented in or by a client, application server(s) 130, and/or any other element/device discussed herein. The system 800 may include one or more of application circuitry 805, baseband circuitry 810, one or more radio front end modules 815, memory 820, power management integrated circuitry (PMIC) 825, power tee circuitry 830, network controller 835, network interface connector 840, satellite positioning circuitry 845, and user interface 850. In some embodiments, the device 800 may include additional elements such as, for example, memory/storage, display, camera, sensor, or input/output (I/O) interface. In other embodiments, the components described below may be included in more than one device (e.g., said circuitries may be separately included in more than one device for some implementations).

As used herein, the term “circuitry” may refer to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (for example, a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality. In addition, the term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The terms “application circuitry” and/or “baseband circuitry” may be considered synonymous to, and may be referred to as “processor circuitry.” As used herein, the term “processor circuitry” may refer to, is part of, or includes circuitry capable of sequentially and automatically carrying out a sequence of arithmetic or logical operations; and recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

Application circuitry 805 may include one or more central processing unit (CPU) cores and one or more of cache memory, low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD/)MultiMediaCard (MMC) or similar, Universal Serial Bus (USB) interfaces, Mobile Industry Processor Interface (MIPI) interfaces and Joint Test Access Group (JTAG) test access ports. As examples, the application circuitry 805 may include one or more Intel Pentium®, Core®, or Xeon® processor(s); Advanced Micro Devices (AMD) Ryzen® processor(s), Accelerated Processing Units (APUs), or Epyc® processors; and/or the like. In some embodiments, the system 800 may not utilize application circuitry 805, and instead may include a special-purpose processor/controller to process IP data received from an EPC or 5GC, for example.

Additionally or alternatively, application circuitry 805 may include circuitry such as, but not limited to, one or more field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such embodiments, the circuitry of application circuitry 805 may comprise logic blocks or logic fabric including other interconnected resources that may be programmed to perform various functions, such as the procedures, methods, functions, etc. of the various embodiments discussed herein. In such embodiments, the circuitry of application circuitry 805 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in lookup-tables (LUTs) and the like.

The baseband circuitry 810 may be implemented, for example, as a solder down substrate including one or more integrated circuits, a single packaged integrated circuit soldered to a main circuit board or a multi-chip module containing two or more integrated circuits. Although not shown, baseband circuitry 810 may comprise one or more digital baseband systems, which may be coupled via an interconnect subsystem to a CPU subsystem, an audio subsystem, and an interface subsystem. The digital baseband subsystems may also be coupled to a digital baseband interface and a mixed-signal baseband subsystem via another interconnect subsystem. Each of the interconnect subsystems may include a bus system, point-to-point connections, network-on-chip (NOC) structures, and/or some other suitable bus or interconnect technology, such as those discussed herein. The audio subsystem may include digital signal processing circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry 810 may include protocol processing circuitry with one or more instances of control circuitry (not shown) to provide control functions for the digital baseband circuitry and/or radio frequency circuitry (for example, the radio front end modules 815).

User interface circuitry 850 may include one or more user interfaces designed to enable user interaction with the system 800 or peripheral component interfaces designed to enable peripheral component interaction with the system 800. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a non-volatile memory port, a universal serial bus (USB) port, an audio jack, a power supply interface, etc.

The radio front end modules (RFEMs) 815 may comprise a millimeter wave RFEM and one or more sub-millimeter wave radio frequency integrated circuits (RFICs). In some implementations, the one or more sub-millimeter wave RFICs may be physically separated from the millimeter wave RFEM. The RFICs may include connections to one or more antennas or antenna arrays, and the RFEM may be connected to multiple antennas. In alternative implementations, both millimeter wave and sub-millimeter wave radio functions may be implemented in the same physical radio front end module 815. The RFEMs 815 may incorporate both millimeter wave antennas and sub-millimeter wave antennas.

The memory circuitry 820 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 820 may be implemented as one or more of solder down packaged integrated circuits, socketed memory modules and plug-in memory cards.

The PMIC 825 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 830 may provide for electrical power drawn from a network cable to provide both power supply and data connectivity to the infrastructure equipment 800 using a single cable.

The network controller circuitry 835 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 800 via network interface connector 840 using a physical connection, which may be electrical (commonly referred to as a “copper interconnect”), optical, or wireless. The network controller circuitry 835 may include one or more dedicated processors and/or FPGAs to communicate using one or more of the aforementioned protocol. In some implementations, the network controller circuitry 835 may include multiple controllers to provide connectivity to other networks using the same or different protocols.

The positioning circuitry 845 may include circuitry to receive and decode signals transmitted by one or more navigation satellite constellations of a global navigation satellite system (GNSS). Examples of navigation satellite constellations (or GNSS) may include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 845 may comprise various hardware elements (e.g., including hardware devices such as switches, filters, amplifiers, antenna elements, and the like to facilitate the communications over-the-air (OTA) communications) to communicate with components of a positioning network, such as navigation satellite constellation nodes.

Nodes or satellites of the navigation satellite constellation(s) (“GNSS nodes”) may provide positioning services by continuously transmitting or broadcasting GNSS signals along a line of sight, which may be used by GNSS receivers (e.g., positioning circuitry 845 and/or positioning circuitry implemented by clients or the like) to determine their GNSS position. The GNSS signals may include a pseudorandom code (e.g., a sequence of ones and zeros) that is known to the GNSS receiver and a message that includes a time of transmission (ToT) of a code epoch (e.g., a defined point in the pseudorandom code sequence) and the GNSS node position at the ToT. The GNSS receivers may monitor/measure the GNSS signals transmitted/broadcasted by a plurality of GNSS nodes (e.g., four or more satellites) and solve various equations to determine a corresponding GNSS position (e.g., a spatial coordinate). The GNSS receivers also implement clocks that are typically less stable and less precise than the atomic clocks of the GNSS nodes, and the GNSS receivers may use the measured GNSS signals to determine the GNSS receivers' deviation from true time (e.g., an offset of the GNSS receiver clock relative to the GNSS node time). In some embodiments, the positioning circuitry 845 may include a Micro-Technology for Positioning, Navigation, and Timing (Micro-PNT) IC that uses a master timing clock to perform position tracking/estimation without GNSS assistance.

The GNSS receivers may measure the time of arrivals (ToAs) of the GNSS signals from the plurality of GNSS nodes according to its own clock. The GNSS receivers may determine time of flight (ToF) values for each received GNSS signal from the ToAs and the ToTs, and then may determine, from the ToFs, a three-dimensional (3D) position and clock deviation. The 3D position may then be converted into a latitude, longitude and altitude. The positioning circuitry 845 may provide data to application circuitry 805, which may include one or more of position data or time data. Application circuitry 805 may use the time data to synchronize operations with other devices.

The components shown by FIG. 8 may communicate with one another using interface circuitry. As used herein, the term “interface circuitry” may refer to, is part of, or includes circuitry providing for the exchange of information between two or more components or devices. The term “interface circuitry” may refer to one or more hardware interfaces, for example, buses, input/output (I/O) interfaces, peripheral component interfaces, network interface cards, and/or the like. Any suitable bus technology may be used in various implementations, which may include any number of technologies, including industry standard architecture (ISA), extended ISA (EISA), peripheral component interconnect (PCI), peripheral component interconnect extended (PCIx), PCI express (PCIe), or any number of other technologies. The bus may be a proprietary bus, for example, used in a SoC based system. Other bus systems may be included, such as an I2C interface, an SPI interface, point-to-point interfaces, and a power bus, among others.

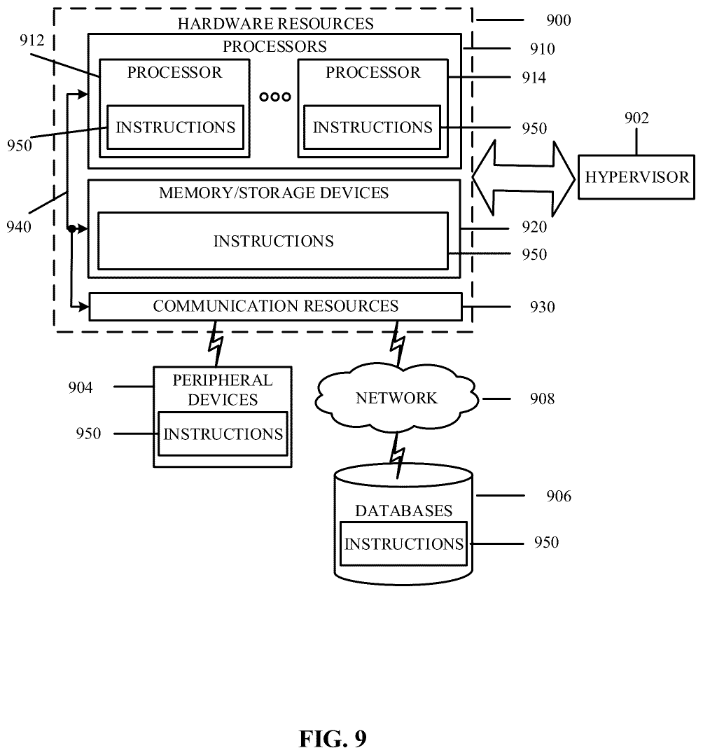

FIG. 9 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors (or processor cores) 910, one or more memory/storage devices 920, and one or more communication resources 930, each of which may be communicatively coupled via a bus 940. For embodiments where node virtualization (e.g., NFV) is utilized, a hypervisor 902 may be executed to provide an execution environment for one or more network slices/sub-slices to utilize the hardware resources 900.

The processors 910 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 912 and a processor 914.

The memory/storage devices 920 may include main memory, disk storage, or any suitable combination thereof. The memory/storage devices 920 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 930 may include interconnection or network interface components or other suitable devices to communicate with one or more peripheral devices 904 or one or more databases 906 via a network 908. For example, the communication resources 930 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

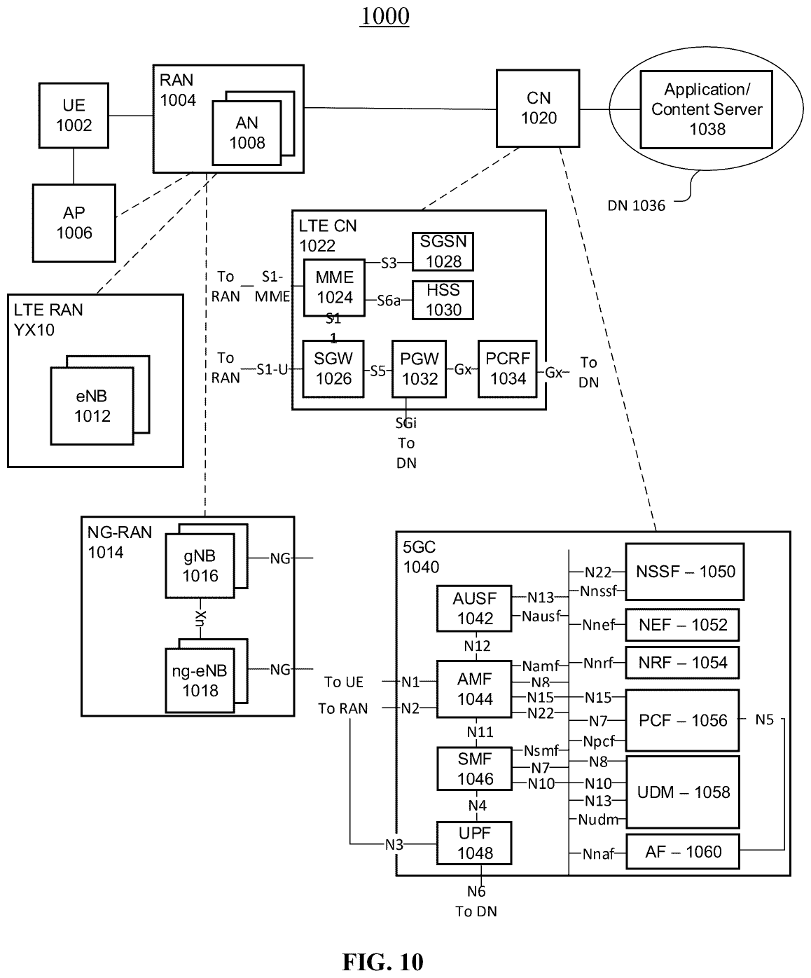

FIG. 10 illustrates a network 1000 in accordance with various embodiments. The network 1000 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1000 may include a UE 1002, which may include any mobile or non-mobile computing device designed to communicate with a RAN 1004 via an over-the-air connection. The UE 1002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1000 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1002 may additionally communicate with an AP 1006 via an over-the-air connection. The AP 1006 may manage a WLAN connection, which may serve to offload some/all network traffic from the RAN 1004. The connection between the UE 1002 and the AP 1006 may be consistent with any IEEE 802.11 protocol, wherein the AP 1006 could be a wireless fidelity (Wi-Fi®) router. In some embodiments, the UE 1002, RAN 1004, and AP 1006 may utilize cellular-WLAN aggregation (for example, LWA/LWIP). Cellular-WLAN aggregation may involve the UE 1002 being configured by the RAN 1004 to utilize both cellular radio resources and WLAN resources.

The RAN 1004 may include one or more access nodes, for example, AN 1008. AN 1008 may terminate air-interface protocols for the UE 1002 by providing access stratum protocols including RRC, PDCP, RLC, MAC, and L1 protocols. In this manner, the AN 1008 may enable data/voice connectivity between CN 1020 and the UE 1002. In some embodiments, the AN 1008 may be implemented in a discrete device or as one or more software entities running on server computers as part of, for example, a virtual network, which may be referred to as a CRAN or virtual baseband unit pool. The AN 1008 be referred to as a BS, gNB, RAN node, eNB, ng-eNB, NodeB, RSU, TRxP, TRP, etc. The AN 1008 may be a macrocell base station or a low power base station for providing femtocells, picocells or other like cells having smaller coverage areas, smaller user capacity, or higher bandwidth compared to macrocells.

In embodiments in which the RAN 1004 includes a plurality of ANs, they may be coupled with one another via an X2 interface (if the RAN 1004 is an LTE RAN) or an Xn interface (if the RAN 1004 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1004 may each manage one or more cells, cell groups, component carriers, etc. to provide the UE 1002 with an air interface for network access. The UE 1002 may be simultaneously connected with a plurality of cells provided by the same or different ANs of the RAN 1004. For example, the UE 1002 and RAN 1004 may use carrier aggregation to allow the UE 1002 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1004 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1002 or AN 1008 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1004 may be an LTE RAN 1010 with eNBs, for example, eNB 1012. The LTE RAN 1010 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1004 may be an NG-RAN 1014 with gNBs, for example, gNB 1016, or ng-eNBs, for example, ng-eNB 1018. The gNB 1016 may connect with 5G-enabled UEs using a 5G NR interface. The gNB 1016 may connect with a 5G core through an NG interface, which may include an N2 interface or an N3 interface. The ng-eNB 1018 may also connect with the 5G core through an NG interface, but may connect with a UE via an LTE air interface. The gNB 1016 and the ng-eNB 1018 may connect with each other over an Xn interface.

In some embodiments, the NG interface may be split into two parts, an NG user plane (NG-U) interface, which carries traffic data between the nodes of the NG-RAN 1014 and a UPF 1048 (e.g., N3 interface), and an NG control plane (NG-C) interface, which is a signaling interface between the nodes of the NG-RAN1014 and an AMF 1044 (e.g., N2 interface).

The NG-RAN 1014 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1002 can be configured with multiple BWPs where each BWP configuration has a different SCS. When a BWP change is indicated to the UE 1002, the SCS of the transmission is changed as well. Another use case example of BWP is related to power saving. In particular, multiple BWPs can be configured for the UE 1002 with different amount of frequency resources (for example, PRBs) to support data transmission under different traffic loading scenarios. A BWP containing a smaller number of PRBs can be used for data transmission with small traffic load while allowing power saving at the UE 1002 and in some cases at the gNB 1016. A BWP containing a larger number of PRBs can be used for scenarios with higher traffic load.

The RAN 1004 is communicatively coupled to CN 1020 that includes network elements to provide various functions to support data and telecommunications services to customers/subscribers (for example, users of UE 1002). The components of the CN 1020 may be implemented in one physical node or separate physical nodes. In some embodiments, NFV may be utilized to virtualize any or all of the functions provided by the network elements of the CN 1020 onto physical compute/storage resources in servers, switches, etc. A logical instantiation of the CN 1020 may be referred to as a network slice, and a logical instantiation of a portion of the CN 1020 may be referred to as a network sub-slice.

In some embodiments, the CN 1020 may be an LTE CN 1022, which may also be referred to as an EPC. The LTE CN 1022 may include MME 1024, SGW 1026, SGSN 108, HSS 1030, PGW 1032, and PCRF 1034 coupled with one another over interfaces (or “reference points”) as shown. Functions of the elements of the LTE CN 1022 may be briefly introduced as follows.

The MME 1024 may implement mobility management functions to track a current location of the UE 1002 to facilitate paging, bearer activation/deactivation, handovers, gateway selection, authentication, etc.

The SGW 1026 may terminate an S1 interface toward the RAN and route data packets between the RAN and the LTE CN 1022. The SGW 1026 may be a local mobility anchor point for inter-RAN node handovers and also may provide an anchor for inter-3GPP mobility. Other responsibilities may include lawful intercept, charging, and some policy enforcement.

The SGSN 108 may track a location of the UE 1002 and perform security functions and access control. In addition, the SGSN 108 may perform inter-EPC node signaling for mobility between different RAT networks; PDN and S-GW selection as specified by MME 1024; MME selection for handovers; etc. The S3 reference point between the MME 1024 and the SGSN 108 may enable user and bearer information exchange for inter-3GPP access network mobility in idle/active states.

The HSS 1030 may include a database for network users, including subscription-related information to support the network entities' handling of communication sessions. The HSS 1030 can provide support for routing/roaming, authentication, authorization, naming/addressing resolution, location dependencies, etc. An S6a reference point between the HSS 1030 and the MME 1024 may enable transfer of subscription and authentication data for authenticating/authorizing user access to the LTE CN 1020.

The PGW 1032 may terminate an SGi interface toward a data network (DN) 1036 that may include an application/content server 1038. The PGW 1032 may route data packets between the LTE CN 1022 and the data network 1036. The PGW 1032 may be coupled with the SGW 1026 by an S5 reference point to facilitate user plane tunneling and tunnel management. The PGW 1032 may further include a node for policy enforcement and charging data collection (for example, PCEF). Additionally, the SGi reference point between the PGW 1032 and the data network 10 36 may be an operator external public, a private PDN, or an intra-operator packet data network, for example, for provision of IMS services. The PGW 1032 may be coupled with a PCRF 1034 via a Gx reference point.

The PCRF 1034 is the policy and charging control element of the LTE CN 1022. The PCRF 1034 may be communicatively coupled to the app/content server 1038 to determine appropriate QoS and charging parameters for service flows. The PCRF 1032 may provision associated rules into a PCEF (via Gx reference point) with appropriate TFT and QCI.

In some embodiments, the CN 1020 may be a 5GC 1040. The 5GC 1040 may include an AUSF 1042, AMF 1044, SMF 1046, UPF 1048, NSSF 1050, NEF 1052, NRF 1054, PCF 1056, UDM 1058, and AF 1060 coupled with one another over interfaces (or “reference points”) as shown. Functions of the elements of the 5GC 1040 may be briefly introduced as follows.

The AUSF 1042 may store data for authentication of UE 1002 and handle authentication-related functionality. The AUSF 1042 may facilitate a common authentication framework for various access types. In addition to communicating with other elements of the 5GC 1040 over reference points as shown, the AUSF 1042 may exhibit an Nausf service-based interface.

The AMF 1044 may allow other functions of the 5GC 1040 to communicate with the UE 1002 and the RAN 1004 and to subscribe to notifications about mobility events with respect to the UE 1002. The AMF 1044 may be responsible for registration management (for example, for registering UE 1002), connection management, reachability management, mobility management, lawful interception of AMF-related events, and access authentication and authorization. The AMF 1044 may provide transport for SM messages between the UE 1002 and the SMF 1046, and act as a transparent proxy for routing SM messages. AMF 1044 may also provide transport for SMS messages between UE 1002 and an SMSF. AMF 1044 may interact with the AUSF 1042 and the UE 1002 to perform various security anchor and context management functions. Furthermore, AMF 1044 may be a termination point of a RAN CP interface, which may include or be an N2 reference point between the RAN 1004 and the AMF 1044; and the AMF 1044 may be a termination point of NAS (N1) signaling, and perform NAS ciphering and integrity protection. AMF 1044 may also support NAS signaling with the UE 1002 over an N3 IWF interface.

The SMF 1046 may be responsible for SM (for example, session establishment, tunnel management between UPF 1048 and AN 1008); UE IP address allocation and management (including optional authorization); selection and control of UP function; configuring traffic steering at UPF 1048 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1044 over N2 to AN 1008; and determining SSC mode of a session. SM may refer to management of a PDU session, and a PDU session or “session” may refer to a PDU connectivity service that provides or enables the exchange of PDUs between the UE 1002 and the data network 1036.

The UPF 1048 may act as an anchor point for intra-RAT and inter-RAT mobility, an external PDU session point of interconnect to data network 1036, and a branching point to support multi-homed PDU session. The UPF 1048 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1048 may include an uplink classifier to support routing traffic flows to a data network.

The NSSF 1050 may select a set of network slice instances serving the UE 1002. The NSSF 1050 may also determine allowed NSSAI and the mapping to the subscribed S-NSSAIs, if needed. The NSSF 1050 may also determine the AMF set to be used to serve the UE 1002, or a list of candidate AMFs based on a suitable configuration and possibly by querying the NRF 1054. The selection of a set of network slice instances for the UE 1002 may be triggered by the AMF 1044 with which the UE 1002 is registered by interacting with the NSSF 1050, which may lead to a change of AMF. The NSSF 1050 may interact with the AMF 1044 via an N22 reference point; and may communicate with another NSSF in a visited network via an N31 reference point (not shown). Additionally, the NSSF 1050 may exhibit an Nnssf service-based interface.

The NEF 1052 may securely expose services and capabilities provided by 3GPP network functions for third party, internal exposure/re-exposure, AFs (e.g., AF 1060), edge computing or fog computing systems, etc. In such embodiments, the NEF 1052 may authenticate, authorize, or throttle the AFs. NEF 1052 may also translate information exchanged with the AF 1060 and information exchanged with internal network functions. For example, the NEF 1052 may translate between an AF-Service-Identifier and an internal 5GC information. NEF 1052 may also receive information from other NFs based on exposed capabilities of other NFs. This information may be stored at the NEF 1052 as structured data, or at a data storage NF using standardized interfaces. The stored information can then be re-exposed by the NEF 1052 to other NFs and AFs, or used for other purposes such as analytics. Additionally, the NEF 1052 may exhibit an Nnef service-based interface.

The NRF 1054 may support service discovery functions, receive NF discovery requests from NF instances, and provide the information of the discovered NF instances to the NF instances. NRF 1054 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1054 may exhibit the Nnrf service-based interface.

The PCF 1056 may provide policy rules to control plane functions to enforce them, and may also support unified policy framework to govern network behavior. The PCF 1056 may also implement a front end to access subscription information relevant for policy decisions in a UDR of the UDM 1058. In addition to communicating with functions over reference points as shown, the PCF 1056 exhibit an Npcf service-based interface.

The UDM 1058 may handle subscription-related information to support the network entities' handling of communication sessions, and may store subscription data of UE 1002. For example, subscription data may be communicated via an N8 reference point between the UDM 1058 and the AMF 1044. The UDM 1058 may include two parts, an application front end and a UDR. The UDR may store subscription data and policy data for the UDM 1058 and the PCF 1056, and/or structured data for exposure and application data (including PFDs for application detection, application request information for multiple UEs 1002) for the NEF 1052. The Nudr service-based interface may be exhibited by the UDR 221 to allow the UDM 1058, PCF 1056, and NEF 1052 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1058 may exhibit the Nudm service-based interface.

The AF 1060 may provide application influence on traffic routing, provide access to NEF, and interact with the policy framework for policy control.

In some embodiments, the 5GC 1040 may enable edge computing by selecting operator/3rd party services to be geographically close to a point that the UE 1002 is attached to the network. This may reduce latency and load on the network. To provide edge-computing implementations, the 5GC 1040 may select a UPF 1048 close to the UE 1002 and execute traffic steering from the UPF 1048 to data network 1036 via the N6 interface. This may be based on the UE subscription data, UE location, and information provided by the AF 1060. In this way, the AF 1060 may influence UPF (re)selection and traffic routing. Based on operator deployment, when AF 1060 is considered to be a trusted entity, the network operator may permit AF 1060 to interact directly with relevant NFs. Additionally, the AF 1060 may exhibit an Naf service-based interface.

The data network 1036 may represent various network operator services, Internet access, or third party services that may be provided by one or more servers including, for example, application/content server 1038.

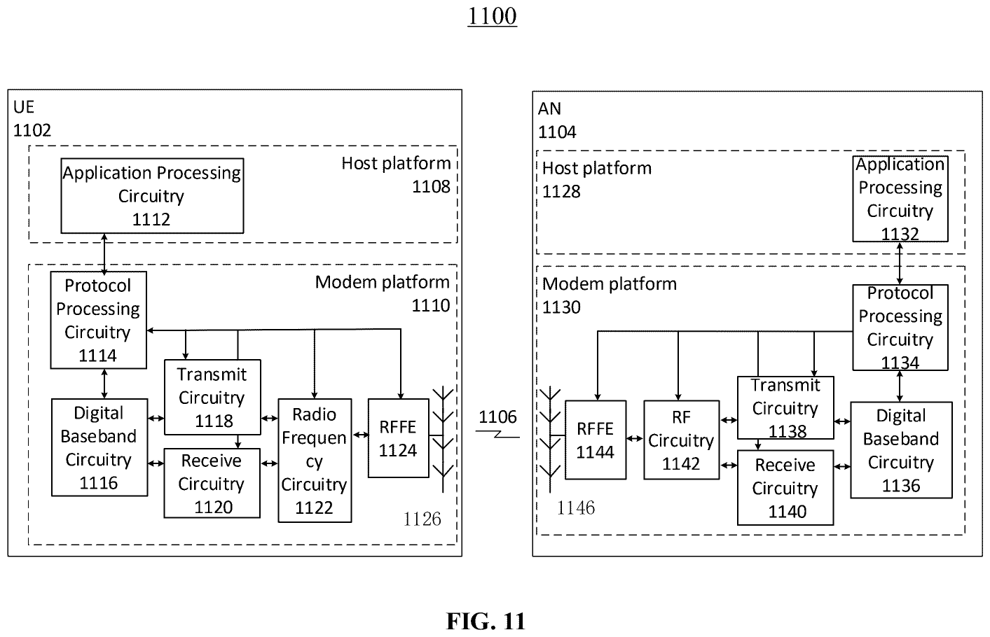

FIG. 11 schematically illustrates a wireless network 1100 in accordance with various embodiments. The wireless network 1100 may include a UE 1102 in wireless communication with an AN 1104. The UE 1102 and AN 1104 may be similar to, and substantially interchangeable with, like-named components described elsewhere herein.

The UE 1102 may be communicatively coupled with the AN 1104 via connection 1106. The connection 1106 is illustrated as an air interface to enable communicative coupling, and can be consistent with cellular communications protocols such as an LTE protocol or a 5G NR protocol operating at mmWave or sub-6 GHz frequencies.

The UE 1102 may include a host platform 1108 coupled with a modem platform 1110. The host platform 1108 may include application processing circuitry 1112, which may be coupled with protocol processing circuitry 1114 of the modem platform 1110. The application processing circuitry 1112 may run various applications for the UE 1102 that source/sink application data. The application processing circuitry 1112 may further implement one or more layer operations to transmit/receive application data to/from a data network. These layer operations may include transport (for example UDP) and Internet (for example, IP) operations

The protocol processing circuitry 1114 may implement one or more of layer operations to facilitate transmission or reception of data over the connection 1106. The layer operations implemented by the protocol processing circuitry 1114 may include, for example, MAC, RLC, PDCP, RRC and NAS operations.

The modem platform 1110 may further include digital baseband circuitry 1116 that may implement one or more layer operations that are “below” layer operations performed by the protocol processing circuitry 1114 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1110 may further include transmit circuitry 1118, receive circuitry 1120, RF circuitry 1122, and RF front end (RFFE) 1124, which may include or connect to one or more antenna panels 1126. Briefly, the transmit circuitry 1118 may include a digital-to-analog converter, mixer, intermediate frequency (IF) components, etc.; the receive circuitry 1120 may include an analog-to-digital converter, mixer, IF components, etc.; the RF circuitry 1122 may include a low-noise amplifier, a power amplifier, power tracking components, etc.; RFFE 1124 may include filters (for example, surface/bulk acoustic wave filters), switches, antenna tuners, beamforming components (for example, phase-array antenna components), etc. The selection and arrangement of the components of the transmit circuitry 1118, receive circuitry 1120, RF circuitry 1122, RFFE 1124, and antenna panels 1126 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1114 may include one or more instances of control circuitry (not shown) to provide control functions for the transmit/receive components.

AUE reception may be established by and via the antenna panels 1126, RFFE 1124, RF circuitry 1122, receive circuitry 1120, digital baseband circuitry 1116, and protocol processing circuitry 1114. In some embodiments, the antenna panels 1126 may receive a transmission from the AN 1104 by receive-beamforming signals received by a plurality of antennas/antenna elements of the one or more antenna panels 1126.

AUE transmission may be established by and via the protocol processing circuitry 1114, digital baseband circuitry 1116, transmit circuitry 1118, RF circuitry 1122, RFFE 1124, and antenna panels 1126. In some embodiments, the transmit components of the UE 1104 may apply a spatial filter to the data to be transmitted to form a transmit beam emitted by the antenna elements of the antenna panels 1126.

Similar to the UE 1102, the AN 1104 may include a host platform 118 coupled with a modem platform 1130. The host platform 118 may include application processing circuitry 1132 coupled with protocol processing circuitry 1134 of the modem platform 1130. The modem platform may further include digital baseband circuitry 1136, transmit circuitry 1138, receive circuitry 1140, RF circuitry 1142, RFFE circuitry 1144, and antenna panels 1146. The components of the AN 1104 may be similar to and substantially interchangeable with like-named components of the UE 1102. In addition to performing data transmission/reception as described above, the components of the AN 1108 may perform various logical functions that include, for example, RNC functions such as radio bearer management, uplink and downlink dynamic radio resource management, and data packet scheduling.

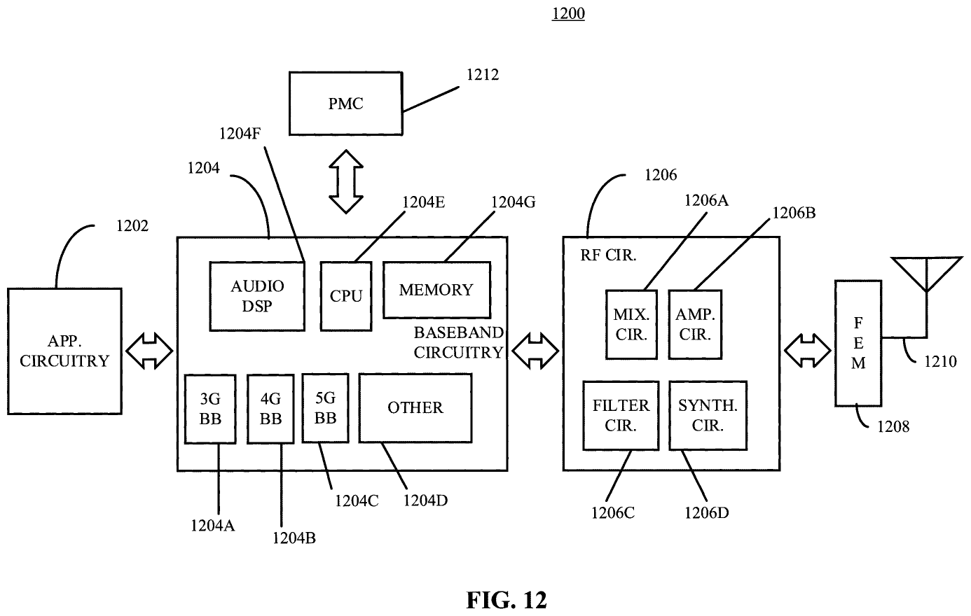

FIG. 12 illustrates example components of a device 1200 in accordance with some embodiments. In some embodiments, the device 1200 may include application circuitry 1202, baseband circuitry 1204, Radio Frequency (RF) circuitry 1206, front-end module (FEM) circuitry 1208, one or more antennas 1210, and power management circuitry (PMC) 1212 coupled together at least as shown. The components of the illustrated device 1200 may be included in a UE or an AN. In some embodiments, the device 1200 may include less elements (e.g., an AN may not utilize application circuitry 1202, and instead include a processor/controller to process IP data received from an EPC). In some embodiments, the device 1200 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1202 may include one or more application processors. For example, the application circuitry 1202 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1200. In some embodiments, processors of application circuitry 1202 may process IP data packets received from an EPC.

The baseband circuitry 1204 may include circuitry such as, but not limited to, one or more single-core or multi-core processors. The baseband circuitry 1204 may include one or more baseband processors or control logic to process baseband signals received from a receive signal path of the RF circuitry 1206 and to generate baseband signals for a transmit signal path of the RF circuitry 1206. Baseband processing circuitry 1204 may interface with the application circuitry 1202 for generation and processing of the baseband signals and for controlling operations of the RF circuitry 1206. For example, in some embodiments, the baseband circuitry 1204 may include a third generation (3G) baseband processor 1204A, a fourth generation (4G) baseband processor 1204B, a fifth generation (5G) baseband processor 1204C, or other baseband processor(s) 1204D for other existing generations, generations in development or to be developed in the future (e.g., sixth generation (6G), etc.). The baseband circuitry 1204 (e.g., one or more of baseband processors 1204A-D) may handle various radio control functions that enable communication with one or more radio networks via the RF circuitry 1206. In other embodiments, some or all of the functionality of baseband processors 1204A-D may be included in modules stored in the memory 1204G and executed via a Central Processing Unit (CPU) 1204E. The radio control functions may include, but are not limited to, signal modulation/demodulation, encoding/decoding, radio frequency shifting, etc. In some embodiments, modulation/demodulation circuitry of the baseband circuitry 1204 may include Fast-Fourier Transform (FFT), precoding, or constellation mapping/demapping functionality. In some embodiments, encoding/decoding circuitry of the baseband circuitry 1204 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1204 may include one or more audio digital signal processor(s) (DSP) 1204F. The audio DSP(s) 1204F may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1204 and the application circuitry 1202 may be implemented together such as, for example, on a system on a chip (SOC).

In some embodiments, the baseband circuitry 1204 may provide for communication compatible with one or more radio technologies. For example, in some embodiments, the baseband circuitry 1204 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 1204 is configured to support radio communications of more than one wireless protocol may be referred to as multi-mode baseband circuitry.

RF circuitry 1206 may enable communication with wireless networks using modulated electromagnetic radiation through a non-solid medium. In various embodiments, the RF circuitry 1206 may include switches, filters, amplifiers, etc. to facilitate the communication with the wireless network. RF circuitry 1206 may include a receive signal path which may include circuitry to down-convert RF signals received from the FEM circuitry 1208 and provide baseband signals to the baseband circuitry 1204. RF circuitry 1206 may also include a transmit signal path which may include circuitry to up-convert baseband signals provided by the baseband circuitry 1204 and provide RF output signals to the FEM circuitry 1208 for transmission.

In some embodiments, the receive signal path of the RF circuitry 1206 may include mixer circuitry 1206a, amplifier circuitry 1206b and filter circuitry 1206c. In some embodiments, the transmit signal path of the RF circuitry 1206 may include filter circuitry 1206c and mixer circuitry 1206a. RF circuitry 1206 may also include synthesizer circuitry 1206d for synthesizing a frequency for use by the mixer circuitry 1206a of the receive signal path and the transmit signal path. In some embodiments, the mixer circuitry 1206a of the receive signal path may be configured to down-convert RF signals received from the FEM circuitry 1208 based on the synthesized frequency provided by synthesizer circuitry 1206d. The amplifier circuitry 1206b may be configured to amplify the down-converted signals and the filter circuitry 1206c may be a low-pass filter (LPF) or band-pass filter (BPF) configured to remove unwanted signals from the down-converted signals to generate output baseband signals. Output baseband signals may be provided to the baseband circuitry 1204 for further processing. In some embodiments, the output baseband signals may be zero-frequency baseband signals, although this is not a requirement. In some embodiments, mixer circuitry 1206a of the receive signal path may comprise passive mixers, although the scope of the embodiments is not limited in this respect.

In some embodiments, the mixer circuitry 1206a of the transmit signal path may be configured to up-convert input baseband signals based on the synthesized frequency provided by the synthesizer circuitry 1206d to generate RF output signals for the FEM circuitry 1208. The baseband signals may be provided by the baseband circuitry 1204 and may be filtered by filter circuitry 1206c.

In some embodiments, the mixer circuitry 1206a of the receive signal path and the mixer circuitry 1206a of the transmit signal path may include two or more mixers and may be arranged for quadrature downconversion and upconversion, respectively. In some embodiments, the mixer circuitry 1206a of the receive signal path and the mixer circuitry 1206a of the transmit signal path may include two or more mixers and may be arranged for image rejection (e.g., Hartley image rejection). In some embodiments, the mixer circuitry 1206a of the receive signal path and the mixer circuitry 1206a of the transmit signal path may be arranged for direct downconversion and direct upconversion, respectively. In some embodiments, the mixer circuitry 1206a of the receive signal path and the mixer circuitry 1206a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1206 may include analog-to-digital converter (ADC) and digital-to-analog converter (DAC) circuitry and the baseband circuitry 1204 may include a digital baseband interface to communicate with the RF circuitry 1206.

In some dual-mode embodiments, a separate radio IC circuitry may be provided for processing signals for each spectrum, although the scope of the embodiments is not limited in this respect.

In some embodiments, the synthesizer circuitry 1206d may be a fractional-N synthesizer or a fractional N/N+1 synthesizer, although the scope of the embodiments is not limited in this respect as other types of frequency synthesizers may be suitable. For example, synthesizer circuitry 1206d may be a delta-sigma synthesizer, a frequency multiplier, or a synthesizer comprising a phase-locked loop with a frequency divider.

The synthesizer circuitry 1206d may be configured to synthesize an output frequency for use by the mixer circuitry 1206a of the RF circuitry 1206 based on a frequency input and a divider control input. In some embodiments, the synthesizer circuitry 1206d may be a fractional N/N+1 synthesizer.

In some embodiments, frequency input may be provided by a voltage controlled oscillator (VCO), although that is not a requirement. Divider control input may be provided by either the baseband circuitry 1204 or the applications processor 1202 depending on the desired output frequency. In some embodiments, a divider control input (e.g., N) may be determined from a look-up table based on a channel indicated by the applications processor 1202.

Synthesizer circuitry 1206d of the RF circuitry 1206 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1206d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1206 may include an IQ/polar converter.

FEM circuitry 1208 may include a receive signal path which may include circuitry configured to operate on RF signals received from one or more antennas 1210, amplify the received signals and provide the amplified versions of the received signals to the RF circuitry 1206 for further processing. FEM circuitry 1208 may also include a transmit signal path which may include circuitry configured to amplify signals for transmission provided by the RF circuitry 1206 for transmission by one or more of the one or more antennas 1210. In various embodiments, the amplification through the transmit or receive signal paths may be done solely in the RF circuitry 1206, solely in the FEM 1208, or in both the RF circuitry 1206 and the FEM 1208.

In some embodiments, the FEM circuitry 1208 may include a TX/RX switch to switch between transmit mode and receive mode operation. The FEM circuitry may include a receive signal path and a transmit signal path. The receive signal path of the FEM circuitry may include an LNAto amplify received RF signals and provide the amplified received RF signals as an output (e.g., to the RF circuitry 1206). The transmit signal path of the FEM circuitry 1208 may include a power amplifier (PA) to amplify input RF signals (e.g., provided by RF circuitry 1206), and one or more filters to generate RF signals for subsequent transmission (e.g., by one or more of the one or more antennas 1210).

In some embodiments, the PMC 1212 may manage power provided to the baseband circuitry 1204. In particular, the PMC 1212 may control power-source selection, voltage scaling, battery charging, or DC-to-DC conversion. The PMC 1212 may often be included when the device 1200 is capable of being powered by a battery, for example, when the device is included in a UE. The PMC 1212 may increase the power conversion efficiency while providing desirable implementation size and heat dissipation characteristics.

While FIG. 12 shows the PMC 1212 coupled only with the baseband circuitry 1204. However, in other embodiments, the PMC 1212 may be additionally or alternatively coupled with, and perform similar power management operations for, other components such as, but not limited to, application circuitry 1202, RF circuitry 1206, or FEM 1208.

In some embodiments, the PMC 1212 may control, or otherwise be part of, various power saving mechanisms of the device 1200. For example, if the device 1200 is in an RRC_Connected state, where it is still connected to the RAN node as it expects to receive traffic shortly, then it may enter a state known as Discontinuous Reception Mode (DRX) after a period of inactivity. During this state, the device 1200 may power down for brief intervals of time and thus save power.

If there is no data traffic activity for an extended period of time, then the device 1200 may transition off to an RRC_Idle state, where it disconnects from the network and does not perform operations such as channel quality feedback, handover, etc. The device 1200 goes into a very low power state and it performs paging where again it periodically wakes up to listen to the network and then powers down again. The device 1200 may not receive data in this state, in order to receive data, it may transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1202 and processors of the baseband circuitry 1204 may be used to execute elements of one or more instances of a protocol stack. For example, processors of the baseband circuitry 1204, alone or in combination, may be used execute Layer 3, Layer 2, or Layer 1 functionality, while processors of the application circuitry 1204 may utilize data (e.g., packet data) received from these layers and further execute Layer 4 functionality (e.g., transmission communication protocol (TCP) and user datagram protocol (UDP) layers). As referred to herein, Layer 3 may comprise a RRC layer. As referred to herein, Layer 2 may comprise a medium access control (MAC) layer, a radio link control (RLC) layer, and a packet data convergence protocol (PDCP) layer. As referred to herein, Layer 1 may comprise a physical (PHY) layer of a UE/RAN node.

The following paragraphs describe examples of various embodiments.

Example 1 includes an apparatus, comprising: a Radio Frequency (RF) interface; and processor circuitry coupled with the RF interface, wherein the processor circuitry is to: encode data, for transmission to an access node (AN) via the RF interface over a pre-allocated uplink (UL) resource (PUR) based physical uplink shared channel (PUSCH); start a timer once the data is transmitted; and monitor, based on the timer, a physical downlink control channel (PDCCH) to obtain a response of the AN to the transmission of the data.

Example 2 includes the apparatus of Example 1, wherein the processor circuitry is further to: determine, if no PDCCH is monitored until the timer expires, that the AN successfully receives the data; and stop monitoring the PDCCH.

Example 3 includes the apparatus of Example 1, wherein if the PDCCH is successfully monitored by the timer expires, the processor circuitry is further to: decode the PDCCH to obtain a hybrid automatic repeat request (HARQ) process ID and a new data indicator (NDI); and determine, when the HARQ process ID is the same as that of the transmission of the data and the NDI indicates that a new data transmission is allowed, that the AN successfully receives the data and the new data transmission is allowed.

Example 4 includes the apparatus of Example 1, wherein if the PDCCH is successfully monitored by the timer expires, the processor circuitry is further to: decode the PDCCH to obtain a hybrid automatic repeat request (HARQ) process ID and a new data indicator (NDI); and determine, when the HARQ process ID is the same as that of the transmission of the data and the NDI indicates that a new data transmission is not allowed, that the AN fails to receive the data and re-transmission of the data is enabled.

Example 5 includes the apparatus of Example 1, wherein the processor circuitry is further to: decode the PDCCH to obtain an indication to indicate a fallback mode for the PUR based PUSCH; and fallback to a 2-step RACH procedure or a 4-step RACH procedure for small data transmission.

Example 6 includes the apparatus of Example 5, wherein the indication is explicitly included in downlink control information (DCI) of the PDCCH or implicitly determined by an existing field of the DCI.

Example 7 includes the apparatus of Example 1, wherein a duration of the timer is configured by higher layer via new radio (NR) remaining minimum system information (RMSI), NR other system information (OSI); or dedicated radio resource control (RRC) signaling.

Example 8 includes the apparatus of Example 1, wherein: the PUR based PUSCH is dedicatedly configured; or the PUR based PUSCH is configured to use the same configuration for Type 1 configured grant PUSCH.

Example 9 includes the apparatus of Example 1, wherein the response includes a HARQ feedback, and wherein the HARQ feedback is explicitly indicated in downlink control information (DCI) of the PDCCH or implicitly determined by an existing field of the DCI.

Example 10 includes the apparatus of Example 1, wherein the response includes a timing advance (TA) adjustment value, and wherein the TA adjustment value is explicitly indicated in downlink control information (DCI) of the PDCCH or implicitly determined by an existing field of the DCI.

Example 11 includes the apparatus of Example 1, wherein the AN includes a next Generation NodeB (gNB).

Example 12 includes an apparatus, comprising: a Radio Frequency (RF) interface; and processor circuitry coupled with the RF interface, wherein the processor circuitry is to: determine, based on one or more timing advance (TA) validation criteria, whether to transmit data over a pre-allocated uplink (UL) resource (PUR) based physical uplink shared channel (PUSCH); and encode, when the one or more TA validation criteria are satisfied, the data for transmission from a user equipment (UE) to an access node (AN) via the RF interface over the PUR based PUSCH.

Example 13 includes the apparatus of Example 12, wherein the one or more TA validation criteria include: a TAvalidation rule for a RRC_INACTIVE mode; a serving cell of the UE keeping unchanged; a transmitting (Tx) beam for the transmission of the data keeping unchanged; or a measured reference signal received power (RSRP) corresponding to a synchronization signal (SS)/physical broadcast channel (PBCH) block (SSB) index for the UE being greater than or equal to a threshold.

Example 14 includes the apparatus of Example 12, wherein the one or more TA validation criteria are configured via higher layer signaling.

Example 15 includes the apparatus of Example 14, wherein the higher layer signaling includes: new radio (NR) remaining minimum system information (RMSI); NR other system information (OSI); or dedicated radio resource control (RRC) signaling.

Example 16 includes an apparatus, comprising: a memory; and processor circuitry coupled with the memory, wherein the processor circuitry is to: monitor, based on a first control resource set (CORESET) and search space (SS) set or a second CORESET and SS set, a physical downlink control channel (PDCCH) during a random access channel (RACH) based small data transmission (RA-SDT) procedure, wherein the first CORESET and SS set is dedicated for PDCCH monitoring during the RA-SDT procedure, and the second CORESET and SS set is used for detecting downlink control information (DCI) format with Cyclic Redundancy Error (CRC) scrambled with random access-radio network temporary identifier (RNTI) (RA-RNTI) or Typel-PDCCH common search space (CSS) set; decode control information of an access node (AN) for a user equipment (UE) from the PDCCH; and perform communication with the AN based on the control information, and wherein the memory is to store the control information.

Example 17 includes the apparatus of Example 16, wherein the processor circuitry is further to: monitor, if the UE is configured with the first CORESET and SS set, the PDCCH based on the first CORESET and SS set.

Example 18 includes the apparatus of Example 16, wherein the processor circuitry is further to: monitor, if the UE is not configured with the first CORESET and SS set, the PDCCH based on the second CORESET and SS set.

Example 19 includes the apparatus of Example 16, wherein the processor circuitry is further to: monitor, regardless of whether the UE is configured with the first CORESET and SS set or not, the PDCCH based on the second CORESET and SS set.

Example 20 includes an apparatus, comprising: a Radio Frequency (RF) interface; and processor circuitry coupled with the RF interface, wherein the processor circuitry is to: decode a packet received from an access node (AN) via the RF interface during a random access channel (RACH) based small data transmission (RA-SDT) procedure; and encode, in response to the packet, a feedback for transmission to the AN via the RF interface over a dedicated physical uplink control channel (PUCCH) resource set for a user equipment (UE) or a common PUCCH resource set.

Example 21 includes the apparatus of Example 20, wherein the processor circuitry is further to: cause transmission of the feedback to the AN over the dedicated PUCCH resource set if the UE is configured with the dedicated PUCCH resource set.

Example 22 includes the apparatus of Example 20, wherein the processor circuitry is further to: cause transmission of the feedback to the AN over the common PUCCH resource set regardless of whether the UE is configured with the dedicated PUCCH resource set or not.

Example 23 includes the apparatus of Example 20, wherein the common PUCCH resource set is configure via remaining minimum system information (RMSI).

Example 24 includes the apparatus of Example 20, wherein the feedback includes a hybrid automatic repeat request (HARQ) feedback.

Example 25 includes a method, comprising: encoding data, for transmission to an access node (AN) over a pre-allocated uplink (UL) resource (PUR) based physical uplink shared channel (PUSCH); starting a timer once the data is transmitted; and monitoring, based on the timer, a physical downlink control channel (PDCCH) to obtain a response of the AN to the transmission of the data.

Example 26 includes the method of Example 25, further comprising: determining, if no PDCCH is monitored until the timer expires, that the AN successfully receives the data; and stopping monitoring the PDCCH.

Example 27 includes the method of Example 25, wherein if the PDCCH is successfully monitored by the timer expires, the method further comprises: decoding the PDCCH to obtain a hybrid automatic repeat request (HARQ) process ID and a new data indicator (NDI); and determining, when the HARQ process ID is the same as that of the transmission of the data and the NDI indicates that a new data transmission is allowed, that the AN successfully receives the data and the new data transmission is allowed.

Example 28 includes the method of Example 25, wherein if the PDCCH is successfully monitored by the timer expires, the method further comprises: decoding the PDCCH to obtain a hybrid automatic repeat request (HARQ) process ID and a new data indicator (NDI); and determining, when the HARQ process ID is the same as that of the transmission of the data and the NDI indicates that a new data transmission is not allowed, that the AN fails to receive the data and re-transmission of the data is enabled.

Example 29 includes the method of Example 25, further comprising: decoding the PDCCH to obtain an indication to indicate a fallback mode for the PUR based PUSCH; and fallbacking to a 2-step RACH procedure or a 4-step RACH procedure for small data transmission.

Example 30 includes the method of Example 29, wherein the indication is explicitly included in downlink control information (DCI) of the PDCCH or implicitly determined by an existing field of the DCI.

Example 31 includes the method of Example 25, wherein a duration of the timer is configured by higher layer via new radio (NR) remaining minimum system information (RMSI), NR other system information (OSI); or dedicated radio resource control (RRC) signaling.

Example 32 includes the method of Example 25, wherein: the PUR based PUSCH is dedicatedly configured; or the PUR based PUSCH is configured to use the same configuration for Type 1 configured grant PUSCH.

Example 33 includes the method of Example 25, wherein the response includes a HARQ feedback, and wherein the HARQ feedback is explicitly indicated in downlink control information (DCI) of the PDCCH or implicitly determined by an existing field of the DCI.

Example 34 includes the method of Example 25, wherein the response includes a timing advance (TA) adjustment value, and wherein the TA adjustment value is explicitly indicated in downlink control information (DCI) of the PDCCH or implicitly determined by an existing field of the DCI.

Example 35 includes the method of Example 25, wherein the AN includes a next Generation NodeB (gNB).

Example 36 includes a method, comprising: determining, based on one or more timing advance (TA) validation criteria, whether to transmit data over a pre-allocated uplink (UL) resource (PUR) based physical uplink shared channel (PUSCH); and encoding, when the one or more TA validation criteria are satisfied, the data for transmission from a user equipment (UE) to an access node (AN) over the PUR based PUSCH.

Example 37 includes the method of Example 36, wherein the one or more TA validation criteria include: a TA validation rule for a RRC_INACTIVE mode; a serving cell of the UE keeping unchanged; a transmitting (Tx) beam for the transmission of the data keeping unchanged; or a measured reference signal received power (RSRP) corresponding to a synchronization signal (SS)/physical broadcast channel (PBCH) block (SSB) index for the UE being greater than or equal to a threshold.

Example 38 includes the method of Example 36, wherein the one or more TA validation criteria are configured via higher layer signaling.

Example 39 includes the method of Example 38, wherein the higher layer signaling includes: new radio (NR) remaining minimum system information (RMSI); NR other system information (OSI); or dedicated radio resource control (RRC) signaling.

Example 40 includes a method, comprising: monitoring, based on a first control resource set (CORESET) and search space (SS) set or a second CORESET and SS set, a physical downlink control channel (PDCCH) during a random access channel (RACH) based small data transmission (RA-SDT) procedure, wherein the first CORESET and SS set is dedicated for PDCCH monitoring during the RA-SDT procedure, and the second CORESET and SS set is used for detecting downlink control information (DCI) format with Cyclic Redundancy Error (CRC) scrambled with random access-radio network temporary identifier (RNTI) (RA-RNTI) or Typel-PDCCH common search space (CSS) set; decoding control information of an access node (AN) for a user equipment (UE) from the PDCCH; and performing communication with the AN based on the control information.

Example 41 includes the method of Example 40, further comprising: monitoring, if the UE is configured with the first CORESET and SS set, the PDCCH based on the first CORESET and SS set.

Example 42 includes the method of Example 40, further comprising: monitoring, if the UE is not configured with the first CORESET and SS set, the PDCCH based on the second CORESET and SS set.

Example 43 includes the method of Example 40, further comprising: monitoring, regardless of whether the UE is configured with the first CORESET and SS set or not, the PDCCH based on the second CORESET and SS set.

Example 44 includes a method, comprising: decoding a packet received from an access node (AN) during a random access channel (RACH) based small data transmission (RA-SDT) procedure; and encoding, in response to the packet, a feedback for transmission to the AN over a dedicated physical uplink control channel (PUCCH) resource set for a user equipment (UE) or a common PUCCH resource set.

Example 45 includes the method of Example 44, further comprising: transmitting the feedback to the AN over the dedicated PUCCH resource set if the UE is configured with the dedicated PUCCH resource set.

Example 46 includes the method of Example 44, further comprising: transmitting the feedback to the AN over the common PUCCH resource set regardless of whether the UE is configured with the dedicated PUCCH resource set or not.

Example 47 includes the method of Example 44, wherein the common PUCCH resource set is configure via remaining minimum system information (RMSI).

Example 48 includes the method of Example 44, wherein the feedback includes a hybrid automatic repeat request (HARQ) feedback.

Example 49 includes an apparatus, comprising: means for encoding data, for transmission to an access node (AN) over a pre-allocated uplink (UL) resource (PUR) based physical uplink shared channel (PUSCH); means for starting a timer once the data is transmitted; and means for monitoring, based on the timer, a physical downlink control channel (PDCCH) to obtain a response of the AN to the transmission of the data.

Example 50 includes the apparatus of Example 49, further comprising: means for determining, if no PDCCH is monitored until the timer expires, that the AN successfully receives the data; and means for stopping monitoring the PDCCH.

Example 51 includes the apparatus of Example 49, wherein if the PDCCH is successfully monitored by the timer expires, the apparatus further comprises: means for decoding the PDCCH to obtain a hybrid automatic repeat request (HARQ) process ID and a new data indicator (NDI); and means for determining, when the HARQ process ID is the same as that of the transmission of the data and the NDI indicates that a new data transmission is allowed, that the AN successfully receives the data and the new data transmission is allowed.

Example 52 includes the apparatus of Example 49, wherein if the PDCCH is successfully monitored by the timer expires, the apparatus further comprises: means for decoding the PDCCH to obtain a hybrid automatic repeat request (HARQ) process ID and a new data indicator (NDI); and means for determining, when the HARQ process ID is the same as that of the transmission of the data and the NDI indicates that a new data transmission is not allowed, that the AN fails to receive the data and re-transmission of the data is enabled.

Example 53 includes the apparatus of Example 49, further comprising: means for decoding the PDCCH to obtain an indication to indicate a fallback mode for the PUR based PUSCH; and means for fallbacking to a 2-step RACH procedure or a 4-step RACH procedure for small data transmission.

Example 54 includes the apparatus of Example 53, wherein the indication is explicitly included in downlink control information (DCI) of the PDCCH or implicitly determined by an existing field of the DCI.

Example 55 includes the apparatus of Example 49, wherein a duration of the timer is configured by higher layer via new radio (NR) remaining minimum system information (RMSI), NR other system information (OSI); or dedicated radio resource control (RRC) signaling.

Example 56 includes the apparatus of Example 49, wherein: the PUR based PUSCH is dedicatedly configured; or the PUR based PUSCH is configured to use the same configuration for Type 1 configured grant PUSCH.

Example 57 includes the apparatus of Example 49, wherein the response includes a HARQ feedback, and wherein the HARQ feedback is explicitly indicated in downlink control information (DCI) of the PDCCH or implicitly determined by an existing field of the DCI.

Example 58 includes the apparatus of Example 49, wherein the response includes a timing advance (TA) adjustment value, and wherein the TA adjustment value is explicitly indicated in downlink control information (DCI) of the PDCCH or implicitly determined by an existing field of the DCI.

Example 59 includes the apparatus of Example 49, wherein the AN includes a next Generation NodeB (gNB).

Example 60 includes an apparatus, comprising: means for determining, based on one or more timing advance (TA) validation criteria, whether to transmit data over a pre-allocated uplink (UL) resource (PUR) based physical uplink shared channel (PUSCH); and means for encoding, when the one or more TA validation criteria are satisfied, the data for transmission from a user equipment (UE) to an access node (AN) over the PUR based PUSCH.

Example 61 includes the apparatus of Example 60, wherein the one or more TA validation criteria include: a TA validation rule for a RRC_INACTIVE mode; a serving cell of the UE keeping unchanged; a transmitting (Tx) beam for the transmission of the data keeping unchanged; or a measured reference signal received power (RSRP) corresponding to a synchronization signal (SS)/physical broadcast channel (PBCH) block (SSB) index for the UE being greater than or equal to a threshold.

Example 62 includes the apparatus of Example 60, wherein the one or more TA validation criteria are configured via higher layer signaling.

Example 63 includes the apparatus of Example 62, wherein the higher layer signaling includes: new radio (NR) remaining minimum system information (RMSI); NR other system information (OSI); or dedicated radio resource control (RRC) signaling.

Example 64 includes an apparatus, comprising: means for monitoring, based on a first control resource set (CORESET) and search space (SS) set or a second CORESET and SS set, a physical downlink control channel (PDCCH) during a random access channel (RACH) based small data transmission (RA-SDT) procedure, wherein the first CORESET and SS set is dedicated for PDCCH monitoring during the RA-SDT procedure, and the second CORESET and SS set is used for detecting downlink control information (DCI) format with Cyclic Redundancy Error (CRC) scrambled with random access-radio network temporary identifier (RNTI) (RA-RNTI) or Type1-PDCCH common search space (CSS) set; means for decoding control information of an access node (AN) for a user equipment (UE) from the PDCCH; and means for performing communication with the AN based on the control information.

Example 65 includes the apparatus of Example 64, further comprising: means for monitoring, if the UE is configured with the first CORESET and SS set, the PDCCH based on the first CORESET and SS set.

Example 66 includes the apparatus of Example 64, further comprising: means for monitoring, if the UE is not configured with the first CORESET and SS set, the PDCCH based on the second CORESET and SS set.

Example 67 includes the apparatus of Example 64, further comprising: means for monitoring, regardless of whether the UE is configured with the first CORESET and SS set or not, the PDCCH based on the second CORESET and SS set.

Example 68 includes an apparatus, comprising: means for decoding a packet received from an access node (AN) during a random access channel (RACH) based small data transmission (RA-SDT) procedure; and means for encoding, in response to the packet, a feedback for transmission to the AN over a dedicated physical uplink control channel (PUCCH) resource set for a user equipment (UE) or a common PUCCH resource set.

Example 69 includes the apparatus of Example 68, further comprising: means for transmitting the feedback to the AN over the dedicated PUCCH resource set if the UE is configured with the dedicated PUCCH resource set.

Example 70 includes the apparatus of Example 68, further comprising: means for transmitting the feedback to the AN over the common PUCCH resource set regardless of whether the UE is configured with the dedicated PUCCH resource set or not.

Example 71 includes the apparatus of Example 68, wherein the common PUCCH resource set is configure via remaining minimum system information (RMSI).

Example 72 includes the apparatus of Example 68, wherein the feedback includes a hybrid automatic repeat request (HARQ) feedback.

Example 73 includes a computer-readable medium having instructions stored thereon, the instructions when executed by processor circuitry cause the processor circuitry to perform the method of any of Examples 25 to 48.

Example 74 includes a user equipment (UE) as shown and described in the description.

Example 75 includes a method performed at a user equipment (UE) as shown and described in the description.

Example 76 includes an access node (AN) as shown and described in the description.

Example 77 includes a method performed at an access node (AN) as shown and described in the description.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the appended claims and the equivalents thereof.

1-20. (canceled)

21. An apparatus for User Equipment (UE), comprising:
a memory; and
processor circuitry coupled with the memory and configured to cause the UE to:
monitor, based on a search space (SS) set, a physical downlink control channel (PDCCH) during a random access based small data transmission (RA-SDT) procedure;
decode control information of an access node (AN) for the UE from the PDCCH; and
perform communication with the AN based on the control information.

22. The apparatus of claim 21, wherein to perform the communication comprises performing the communication in an RRC_INACTIVE state.

23. The apparatus of claim 21, wherein the communication comprises a physical uplink shared channel (PUSCH) transmission.

24. The apparatus of claim 21, wherein the RA-SDT procedure is performed by a 2-step or 4-step Random Access procedure.

25. The apparatus of claim 21, wherein to monitor the PDCCH comprises monitoring the PDCCH until the RA-SDT procedure is terminated.

26. The apparatus of claim 21, wherein the processor circuitry is further configured to cause the UE to:
perform uplink transmission based on configured grant, when a timing advance (TA) is valid.

27. The apparatus of claim 26, wherein if the TA is valid is determined based on one or more parameters configured by radio resource control (RRC) layer.

28. The apparatus of claim 27, wherein the one or more parameters comprise a reference signal received power (RSRP) threshold.

29. The apparatus of claim 26, wherein the TA is determined invalid if a time alignment timer is not running.

30. A computer readable storage medium storing instructions thereon which, when executed by processor circuitry of a User Equipment (UE), cause the UE to:
monitor, based on a search space (SS) set, a physical downlink control channel (PDCCH) during a random access based small data transmission (RA-SDT) procedure;
decode control information of an access node (AN) for the UE from the PDCCH; and
perform communication with the AN based on the control information.

31. The computer readable storage medium of claim 30, wherein to perform the communication comprises performing the communication in an RRC_INACTIVE state.

32. The computer readable storage medium of claim 30, wherein the communication comprises a physical uplink shared channel (PUSCH) transmission.

33. The computer readable storage medium of claim 30, wherein the RA-SDT procedure is performed by a 2-step or 4-step Random Access procedure.

34. The computer readable storage medium of claim 30, wherein to monitor the PDCCH comprises monitoring the PDCCH until the RA-SDT procedure is terminated.

35. The computer readable storage medium of claim 30, wherein the instructions when executed by the processor circuitry further cause the UE to:
perform uplink transmission based on configured grant, when a timing advance (TA) is valid.

36. The computer readable storage medium of claim 35, wherein if the TA is valid is determined based on one or more parameters configured by radio resource control (RRC) layer.

37. The computer readable storage medium of claim 36, wherein the one or more parameters comprise a reference signal received power (RSRP) threshold.

38. The computer readable storage medium of claim 35, wherein the TA is determined invalid if a time alignment timer is not running.

39. User Equipment (UE), comprising:
a memory for storing instructions; and
processor circuitry coupled to the memory, wherein the instructions, when executed by the processor circuitry, cause the UE to:
monitor, based on a search space (SS) set, a physical downlink control channel (PDCCH) during a random access based small data transmission (RA-SDT) procedure;
decode control information of an access node (AN) for the UE from the PDCCH; and
perform communication with the AN based on the control information.

40. The UE of claim 39, wherein to perform the communication comprises performing the communication in an RRC_INACTIVE state.
